(19) United States
(12) Patent Application Publication
(10) Pub. No.: US 2013/0028645 A1
(43) Pub. Date: Jan. 31, 2013

(54) MULTI-COMPONENT DUPLEX PRINTER

(71) Applicants: Michael Thomas Dobbertin, Honeoye, NY (US); Timothy John Young, Williamson, NY (US)

(72) Inventors: Michael Thomas Dobbertin, Honeoye, NY (US); Timothy John Young, Williamson, NY (US)

(21) Appl. No.: 13/191,800

(22) Filed: Jul. 27, 2011

(51) Int. Cl. G03G 13/00

(52) U.S. Cl. 399/364

(57) ABSTRACT

A multi-component duplex print is produced on a receiver. Master print engines and slave print engines synchronized to the masters are arranged along the transport path of the receiver with inverters between them. Each inverter has an inverted travel path and a non-inverted travel path, and a difference of a travel time of the receiver in the inverted travel path of each inverter as compared to a travel time of a receiver in the non-inverted travel path of that inverter is adjusted to be an integral multiple of a period between successive receivers. A received job specification designating a first assigned one of the print engines to print on a first assigned side of the receiver. A controller sets the positions of the inverters so the first assigned side of the moving receiver is the corresponding print side of the first assigned print engine.

### FIELD OF THE INVENTION

The claimed invention relates in general to imaging systems having more than one print engine, and more particularly to producing a multi-component duplex print using multiple print engines.

### BACKGROUND OF THE INVENTION

Electrographic reproduction devices use a latent image charge pattern formed on a uniformly charged charge-retentive or photoconductive member having dielectric characteristics (hereinafter referred to as the dielectric support member). Marking particles (which can contain dyes or pigments) are attracted to the latent image charge pattern to develop the latent image into a developed image on the dielectric support member. A receiver member, such as a sheet of paper, transparency or other medium, is then brought directly, or indirectly via an intermediate transfer member, into contact with the dielectric support member, and an electric field is applied to transfer the marking particle developed image to the receiver member from the dielectric support member to form a print image on the receiver member. After transfer, the receiver member bearing the transferred image is transported away from the dielectric support member, and the image is fixed (fused) to the receiver member by heat or pressure to form a permanent reproduction thereon.

Inkjet printers deposit drops of pigment- or dye-bearing ink or other jetting fluid at specific locations on a receiver member to make a pattern. The inks can be liquid (and remain liquid upon striking the receiver member). The inks can also be “quick-melt”: solid ink is melted just before jetting, then the liquid ink cools quickly back to a solid state upon striking the receiver member.

An electrophotographic or inkjet reproduction apparatus generally is designed to produce a specific number of prints per minute. For example, a printer can be capable of producing 150 single-sided pages per minute (ppm) or approximately 75 double-sided pages per minute with an appropriate duplexing technology. Small upgrades in system throughput can be achievable in robust printing systems, however, the doubling of throughput speed is mainly unachievable without a) purchasing a second reproduction apparatus with throughput identical to the first so that the two machines can be run in parallel, or without b) replacing the first reproduction apparatus with a radically redesigned print engine having double the speed. Both options are very expensive and often with regard to option (b), not possible.

Another option for increasing reproduction apparatus throughput is to use a second print engine in series with a first print engine. For example, U.S. Pat. No. 7,245,856 discloses a tandem printing system which is configured to reduce image registration errors between a first side image formed by a first print engine and a second side image formed by a second print engine. Each of the '856 print engines has a photoconductive belt having a seam. The seams of the photoconductive belt in each print engine are synchronized by tracking a phase difference between seam signals from both belts. Synchronization of a slave print engine to a main print engine occurs once per revolution of the belts, as triggered by a belt seam signal, and the velocity of the slave photoconductor and the velocity of an imager motor and polygon assembly are updated to match the velocity of the master photoconductor. Unfortunately, such a system tends to be susceptible to increasing registration errors during each successive image frame during the photoconductor revolution. Furthermore, given the large inertia of the high-speed rotating polygon assembly, it is difficult to make significant adjustments to the velocity of the polygon assembly in the relatively short time frame of a single photoconductor revolution. This can limit the response of the '856 system on a per revolution basis, and make it even more difficult, if not impossible, to adjust on a more frequent basis.

### SUMMARY OF THE INVENTION

Moreover, each print engine only holds certain colorants at a time. Using multiple print engines therefore limits the options of colorant deposition available without reconfiguring one or more engines. This can require changing toner or ink cartridges between print jobs.

Therefore, there is a continuing need for an effective way of providing a printer having high duplex throughput and flexibility to handle different types of jobs without reconfiguring the machine. There is also a continuing need for a printer that operates at high productivity when switching back and forth between the duplex mode and a simplex mode, or when switching between job configurations.

According to an aspect of the present invention, therefore, there is provided a method for producing a multi-component duplex print on a receiver member having front and back sides according to a job specification, the method comprising:

arranging one or more master print engines, one or more slave print engines, and one or more inverters along a transport path of the receiver member, each inverter arranged between a pair of adjacent print engines,
so that each print engine prints on a corresponding print side of the moving receiver member, and the first print engine along the transport path prints on the front side of the receiver;
wherein each master print engine provides a respective timing signal and each inverter is operative to pass the moving receiver member between the corresponding print engines along an inverted travel path when in an invert position and along a non-inverted travel path when in a non-invert position;

synchronizing the timing of each slave print engine to the timing of a corresponding master print engine using a controller responsive to the timing signal received from the corresponding master print engine;

adjusting a difference of a travel time of the receiver member in the inverted travel path of each inverter as compared to a travel time of a receiver member in the non-inverted travel path of that inverter to be an integral multiple of a period between successive receiver members;

receiving the job specification designating a first assigned one of the print engines to print on a first assigned side of the receiver member; and

the controller setting the positions of the inverters so the first assigned side of the moving receiver member is the corresponding print side of the first assigned print engine.

According to another aspect of the present invention, there is provided a method for producing a multi-component print on a receiver member having front and back sides according to a job specification, the method comprising:

arranging a master print engine, a slave print engine, and an inverter along a transport path of the receiver member, the inverter arranged between the print engines,
so that each print engine prints on a corresponding print side of the moving receiver member, and the first print engine along the transport path prints on the front side of the receiver;
wherein the master print engine provides a respective timing signal and the inverter is operative to pass the moving receiver member between the print engines along an inverted travel path when in an invert position and along a non-inverted travel path when in a non-invert position;

synchronizing the timing of the slave print engine to the timing of the master print engine using a controller responsive to the timing signal received from the master print engine;

adjusting a difference of a travel time of the receiver member in the inverted travel path of the inverter as compared to a travel time of a receiver member in the non-inverted travel path of the inverter to be an integral multiple of a period between successive receiver members;

receiving the job specification designating a first assigned one of the print engines to print on a first assigned side of the receiver member, and a second assigned one of the print engines to print on a second assigned side of the receiver member; and

the controller setting the position of the inverter so the first assigned side of the moving receiver member is the corresponding print side of the first assigned print engine and the second assigned side of the moving receiver member is the corresponding print side of the second assigned print engine.

An advantage of the present invention is that it can print simplex and duplex print jobs, and duplex print jobs with specific components on different sides, without reconfiguring the printer. Consecutive print jobs with different modes can be printed without loss of efficiency, since the printer can switch between print modes without stopping or pausing.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 schematically illustrates an embodiment of an electrophotographic print engine;

FIG. 2 schematically illustrates an embodiment of a reproduction apparatus having a first print engine;

FIGS. 3A-3C schematically illustrate embodiments of a reproduction apparatus having a first print engine and a tandem second print engine from a productivity module;

FIG. 4 schematically illustrates an embodiment of a reproduction apparatus having embodiments of first and second print engines which are synchronized by a controller;

FIG. 5 schematically illustrates time offsets between image frames on a first dielectric support member (DSM) and image frames on a second DSM;

FIG. 6 illustrates one embodiment of a method for synchronizing first and second print engines;

FIG. 7 illustrates another embodiment of a method for synchronizing first and second print engines;

FIG. 8 schematically illustrates a timing diagram representing an embodiment of print engine synchronization;

FIG. 9 schematically illustrates another embodiment of a reproduction apparatus;

FIG. 10 schematically illustrates one embodiment of an inverter for coupling a first print engine to a second print engine in a productivity module;

FIG. 11 schematically illustrates an embodiment of a productivity module for increasing duplex throughput of a first print engine;

FIGS. 12A-12C schematically illustrate embodiments of transport path routing options for an embodiment of an inverter in a productivity module;

FIG. 13 illustrates one embodiment of a method of increasing productivity in a reproduction apparatus having a first print engine and a second print engine coupled by an inverter when switching between an invert mode and a non-invert mode;

FIG. 14 is a high-level diagram showing the components of a processing system useful with various embodiments;

FIG. 15 is a flowchart of various embodiments of methods for producing a multi-component duplex print on a receiver member having front and back sides according to a job specification;

FIG. 16 is a schematic of an embodiment of a printer;

FIG. 17 is a flowchart of methods for producing a multi-component duplex print using a printer such as that shown in FIG. 16;

FIG. 18 is a schematic of an embodiment of a printer;

FIG. 19 is a flowchart of methods for producing a multi-component duplex print using a printer such as that shown in FIG. 18;

FIG. 20 is a schematic of an embodiment of a printer;

FIG. 21 is a flowchart of methods for producing a multi-component duplex print using a printer such as that shown in FIG. 20;

FIG. 22 is a schematic of an embodiment of a printer; and

FIG. 23 is a flowchart of methods for producing a multi-component duplex print using a printer such as that shown in FIG. 22.

FIG. 24 is a schematic of an embodiment of a printer; and

FIG. 25 is a flowchart of methods for producing a multi-component duplex print using a printer such as that shown in FIG. 24.

The attached drawings are for purposes of illustration and are not necessarily to scale.

### DETAILED DESCRIPTION OF THE INVENTION

Reference is made to U.S. patent application Ser. No. 12/128,897, filed May 29, 2008 (Published as US 2009029740), and to U.S. patent application Ser. No. 13/047,939, filed Mar. 15, 2011, the disclosures of which are hereby incorporated herein by reference.

Examples of inkjet printers are found in U.S. Patent Publication 20110148999, filed Dec. 21, 2009 (drop-on-demand) by O'Leary, et al, U.S. Pat. No. 6,505,921 to Chwalek et al. (continuous), and U.S. Pat. No. 6,508,543 to Hawkins et al. (continuous), the disclosures of which are incorporated herein by reference. Drop-on-demand or continuous inkjet printers can be used with various embodiments. In a drop-on-demand printer, ink is forced out of a nozzle by heat or pressure (e.g., piezoelectric) whenever a location of the receiver member that should receive a drop is in position with respect to the nozzle. In a continuous-inkjet printer, drops are forced out of a nozzle at a regular rate, and drops are deflected so that only the desired drops land on the receiver member to form a print image.

In the following description, some embodiments will be described in terms that would ordinarily be implemented as software programs. Those skilled in the art will readily recognize that the equivalent of such software can also be constructed in hardware. Because image manipulation algorithms and systems are well known, the present description will be directed in particular to algorithms and systems forming part of, or cooperating more directly with, methods described herein. Other aspects of such algorithms and systems, and hardware or software for producing and otherwise processing the image signals involved therewith, not specifically shown or described herein, are selected from such systems, algorithms, components, and elements known in the art. Given the system as described herein, software not specifically shown, suggested, or described herein that is useful for implementation of various embodiments is conventional and within the ordinary skill in such arts.

A computer program product can include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice methods according to various embodiments.

The terms “printer” and “reproduction apparatus,” as used herein, include devices such as printers, copiers, scanners, and facsimiles, and analog or digital devices. The term “print image” refers to any determined pattern of toner or ink deposited on a receiver member.

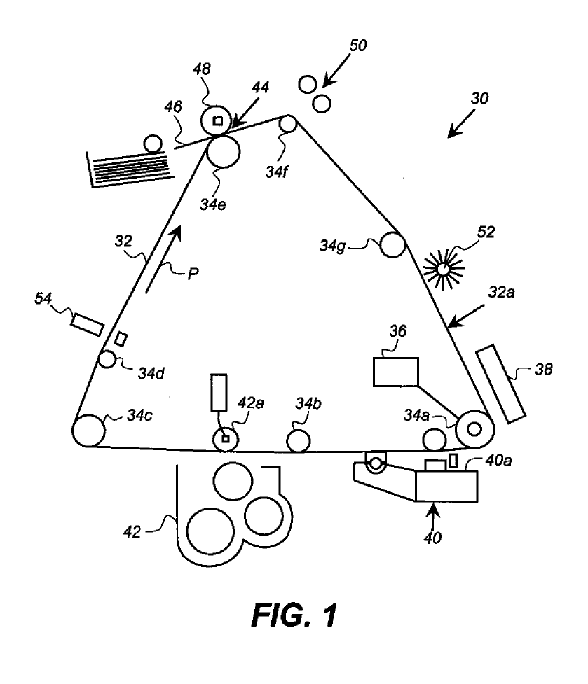

FIG. 1 schematically illustrates an embodiment of an electrophotographic print engine 30. The print engine 30 has a movable recording member such as a photoconductive belt 32 which is entrained about a plurality of rollers or other supports 34a through 34g. The photoconductive belt 32 can be more generally referred-to as a dielectric support member (DSM) 32. A dielectric support member (DSM) 32 can be any charge carrying substrate which can be selectively charged or discharged by a variety of methods including, but not limited to corona charging/discharging, gated corona charging/discharging, charge roller charging/discharging, ion writer charging, light discharging, heat discharging, and time discharging.

One or more of the rollers 34a-34g are driven by a motor 36 to advance the DSM 32. Motor 36 preferably advances the DSM 32 at a high speed, such as 20 inches per second or higher, in the direction indicated by arrow P, past a series of workstations of the print engine 30, although other operating speeds can be used, depending on the embodiment. In some embodiments, DSM 32 can be wrapped and secured about only a single drum. In further embodiments, DSM 32 can be coated onto or integral with a drum.

Print engine 30 can include a controller or logic and control unit (LCU) (not shown). The LCU can be a computer, microprocessor, application specific integrated circuit (ASIC), digital circuitry, analog circuitry, or a combination or plurality thereof. The controller (LCU) can be operated according to a stored program for actuating the workstations within print engine 30, effecting overall control of print engine 30 and its various subsystems. The LCU can also be programmed to provide closed-loop control of the print engine 30 in response to signals from various sensors and encoders. Aspects of process control are described in U.S. Pat. No. 6,121,986 incorporated herein by this reference.

A primary charging station 38 in print engine 30 sensitizes DSM 32 by applying a uniform electrostatic corona charge, from high-voltage charging wires at a predetermined primary voltage, to a surface 32a of DSM 32. The output of charging station 38 can be regulated by a programmable voltage controller (not shown), which can in turn be controlled by the LCU to adjust this primary voltage, for example by controlling the electrical potential of a grid and thus controlling movement of the corona charge. Other forms of chargers, including brush or roller chargers, can also be used.

An image writer, such as exposure station 40 in print engine 30 projects light from a writer 40a to DSM 32. This light selectively dissipates the electrostatic charge on photoconductive DSM 32 to form a latent electrostatic image of the document to be copied or printed. Writer 40a is preferably constructed as an array of light emitting diodes (LEDs), or alternatively as another light source such as a Laser or spatial light modulator. Writer 40a exposes individual picture elements (pixels) of DSM 32 with light at a regulated intensity and exposure, in the manner described below. The exposing light discharges selected pixel locations of the photoconductor, so that the pattern of localized voltages across the photoconductor corresponds to the image to be printed. An image is a pattern of physical light which can include characters, words, text, and other features such as graphics and photos. An image can be included in a set of one or more images, such as in images of the pages of a document. An image can be divided into segments, objects, or structures each of which is itself an image. A segment, object, or structure of an image can be of any size up to and including the whole image.

After exposure, the portion of DSM 32 bearing the latent charge images travels to a development station 42. Development station 42 includes a magnetic brush in juxtaposition to the DSM 32. Magnetic brush development stations are well known in the art, and are preferred in many applications; alternatively, other known types of development stations or devices can be used. Plural development stations 42 can be provided for developing images in plural grey scales, colors, or from toners of different physical characteristics. Full process color electrographic printing is accomplished using this process for each of four toner colors (e.g., black, cyan, magenta, yellow).

Upon the imaged portion of DSM 32 reaching development station 42, the LCU selectively activates development station 42 to apply toner to DSM 32 by moving backup roller 42a and DSM 32, into engagement with or close proximity to the magnetic brush. Alternatively, the magnetic brush can be moved toward DSM 32 to selectively engage DSM 32. In either case, charged toner particles on the magnetic brush are selectively attracted to the latent image patterns present on DSM 32, developing those image patterns. As the exposed photoconductor passes the developing station, toner is attracted to pixel locations of the photoconductor and as a result, a pattern of toner corresponding to the image to be printed appears on the photoconductor. As known in the art, conductor portions of development station 42, such as conductive applicator cylinders, are biased to act as electrodes. The electrodes are connected to a variable supply voltage, which is regulated by a programmable controller in response to the LCU, by way of which the development process is controlled.

Development station 42 can contain a two component developer mix which includes a dry mixture of toner and carrier particles. Typically the carrier preferably includes high coercivity (hard magnetic) ferrite particles. As a non-limiting example, the carrier particles can have a volume-weighted diameter of approximately 30 μm. The dry toner particles are substantially smaller, on the order of 6 μm to 15 μm in volume-weighted diameter. Development station 42 can include an applicator having a rotatable magnetic core within a shell, which also can be rotatably driven by a motor or other suitable driving structures. Relative rotation of the core and shell moves the developer through a development zone in the presence of an electrical field. In the course of development, the toner selectively electrostatically adheres to DSM 32 to develop the electrostatic images thereon and the carrier material remains at development station 42. As toner is depleted from the development station due to the development of the electrostatic image, additional toner can be periodically introduced by a toner auger (not shown) into development station 42 to be mixed with the carrier particles to maintain a uniform amount of development mixture. This development mixture is controlled in accordance with various development control processes. Single component developer stations, as well as conventional liquid toner development stations, can also be used.

A transfer station 44 in printing machine 10 moves a receiver member 46 into engagement with the DSM 32, in registration with a developed image to transfer the developed image to receiver member 46. Receiver members 46 can be plain or coated paper, plastic, or another medium capable of being handled by the print engine 30. Typically, transfer station 44 includes a charging device for electrostatically biasing movement of the toner particles from DSM 32 to receiver member 46. In this example, the biasing device is roller 48, which engages the back of sheet 46 and which can be connected to a programmable voltage controller that operates in a constant current mode during transfer. Alternatively, an intermediate member can have the image transferred to it and the image can then be transferred to receiver member 46. After transfer of the toner image to receiver member 46, sheet 46 is detacked from DSM 32 and transported to fuser station 50 where the image is fixed onto sheet 46, typically by the application of heat or pressure. Alternatively, the image can be fixed to sheet 46 at the time of transfer.

A cleaning station 52, such as a brush, blade, or web is also located beyond transfer station 44, and removes residual toner from DSM 32. A pre-clean charger (not shown) can be located before or at cleaning station 52 to assist in this cleaning. After cleaning, this portion of DSM 32 is then ready for recharging and re-exposure. Of course, other portions of DSM 32 are simultaneously located at the various workstations of print engine 30, so that the printing process can be carried out in a substantially continuous manner.

A controller provides overall control of the apparatus and its various subsystems with the assistance of one or more sensors which can be used to gather control process input data. One example of a sensor is belt position sensor 54.

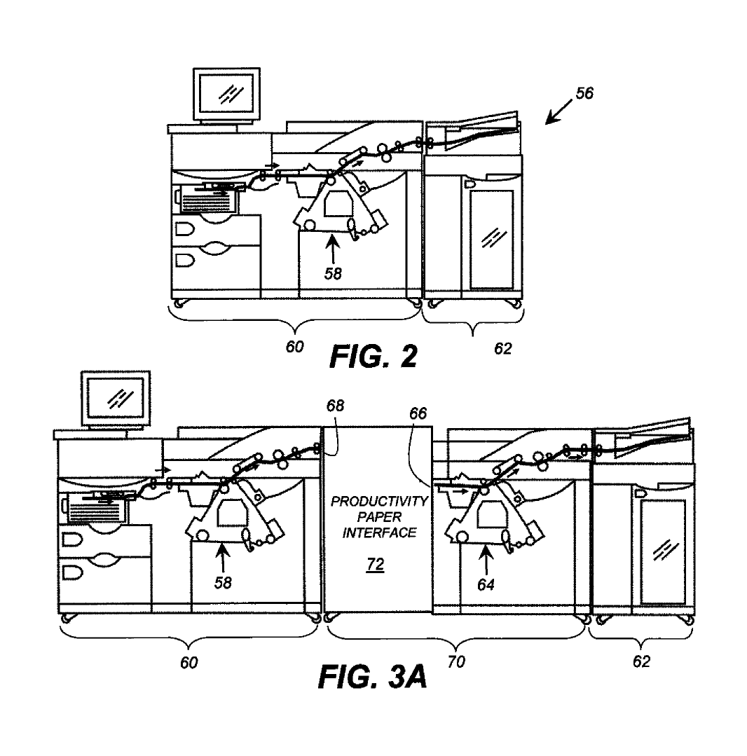

FIG. 2 schematically illustrates an embodiment of a reproduction apparatus 56 having a first print engine 58. The embodied reproduction apparatus will have a particular throughput which can be measured in pages per minute (ppm). As explained above, it would be desirable to be able to significantly increase the throughput of such a reproduction apparatus 56 without having to purchase an entire second reproduction apparatus. It would also be desirable to increase the throughput of reproduction apparatus 56 without having to scrap apparatus 56 and replacing it with an entire new machine.

Quite often, reproduction apparatus 56 is made up of modular components. For example, the print engine 58 is housed within a main cabinet 60 that is coupled to a finishing unit 62. For simplicity, only a single finishing device 62 is shown, however, it should be understood that multiple finishing devices providing a variety of finishing functionality are known to those skilled in the art and can be used in place of a single finishing device. Depending on its configuration, the finishing device 62 can provide stapling, hole-punching, trimming, cutting, slicing, stacking, paper insertion, collation, sorting, and binding.

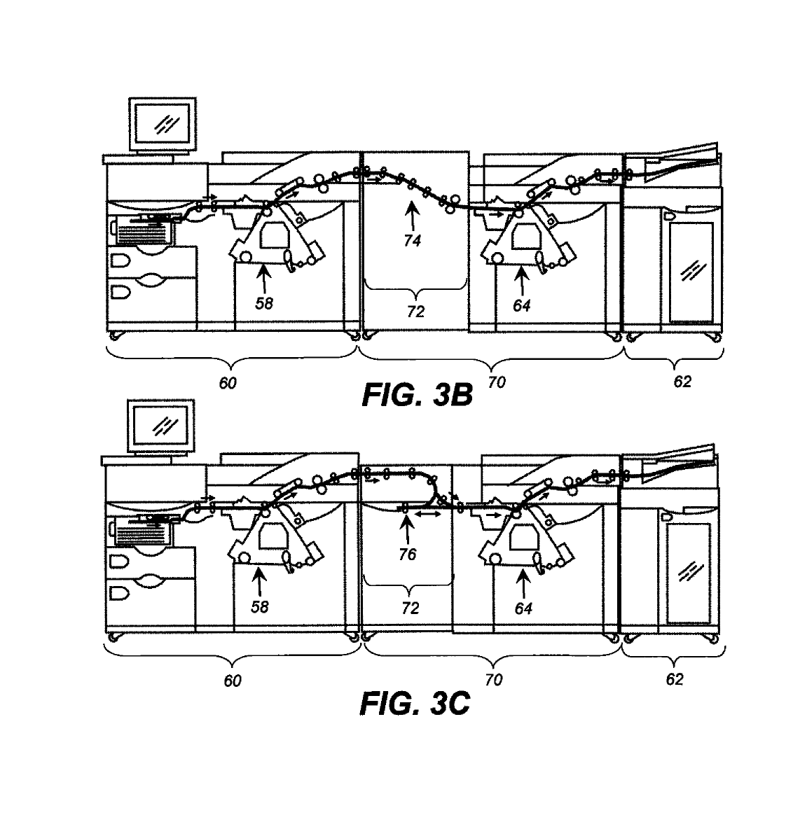

As FIG. 3A schematically illustrates, a second print engine 64 can be inserted in-line with the first print engine 58 and in-between the first print engine 58 and the finishing device 62 formerly coupled to the first print engine 58. The second print engine 64 can have an input transport path point 66 which does not align with the output transport path point 68 from the first print engine 58. Additionally, or optionally, it can be desirable to invert the receiver members from the first print engine 58 prior to running them through the second print engine (for duplex prints). In such instances, the productivity module 70 which is inserted between the first print engine 58 and the at least one finisher 62 can have a productivity transport interface 72. Some embodiments of a productivity transport interface 72 can provide for matching 74 of differing output and input receiver-sheet heights, as illustrated in the embodiment of FIG. 3B. Other embodiments of a productivity transport interface 72 can provide for inversion 76 of receiver members, as illustrated in the embodiment of FIG. 3C.

Providing users with the option to re-use their existing equipment by inserting a productivity module 70 between their first print engine 58 and their one or more finishing devices 62 can be economically attractive since the second print engine 64 of the productivity module 70 does not need to come equipped with the input receiver-member handling drawers coupled to the first print engine 58. Furthermore, the second print engine 64 can be based on the existing technology of the first print engine 58 with control modifications which will be described in more detail below to facilitate synchronization between the first and second print engines.

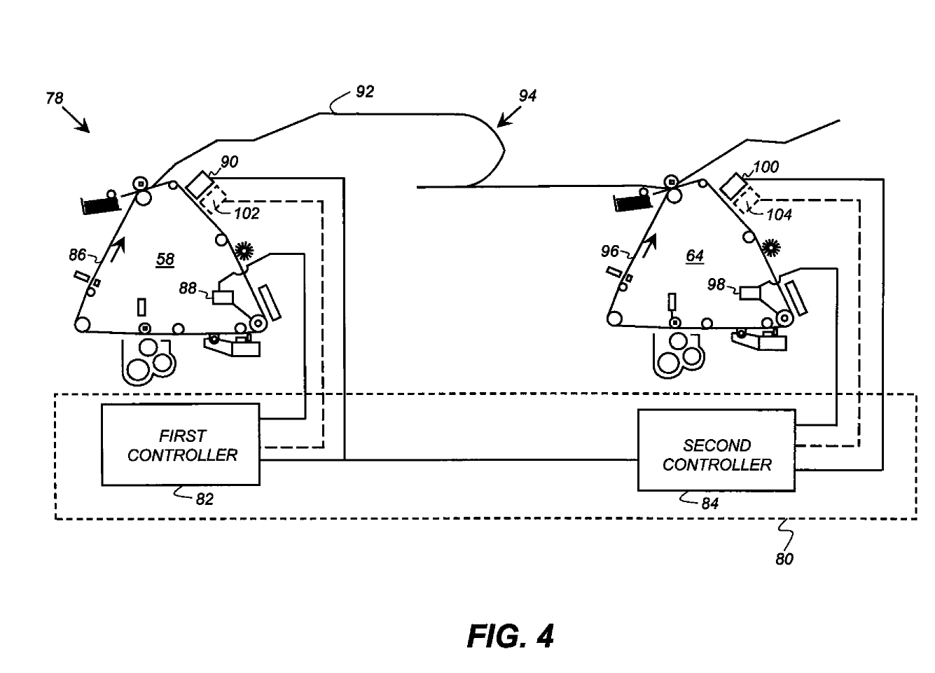

FIG. 4 schematically illustrates an embodiment of a reproduction apparatus 78 having embodiments of first and second print engines 58, 64 which are synchronized by a controller 80. In various embodiments, first print engine 58 is a master print engine and second print engine 64 is a slave print engine. Controller 80 can be a computer, a microprocessor, an application specific integrated circuit, digital circuitry, analog circuitry, or any combination or plurality thereof. In this embodiment, the controller 80 includes a first controller 82 and a second controller 84. Optionally, in other embodiments, the controller 80 is a single controller as indicated by the dashed line for controller 80. The first print engine 58 has a first dielectric support member (DSM) 86, the features of which have been discussed above with regard to the DSM of FIG. 1. The first DSM 86 also preferably has a plurality of frame markers corresponding to a plurality of frames on the DSM 86. In some embodiments, the frame markers can be holes or perforations in the DSM 86 which an optical sensor can detect. In other embodiments, the frame markers can be reflective or diffuse areas on the DSM which an optical sensor can detect. Other types of frame markers will be apparent to those skilled in the art and are intended to be included within the scope of this specification. The first print engine 58 also has a first motor 88 coupled to the first DSM 86 for moving the first DSM when enabled. As used here, the term “enabled” refers to embodiments where the first motor 88 can be dialed in to one or more desired speeds as opposed to just an on/off operation. Other embodiments, however, can selectively enable the first motor 88 in an on/off fashion or in a pulse-width-modulation fashion.

The first controller 82 is coupled to the first motor 88 and is configured to selectively enable the first motor 88 (for example, by setting the motor for a desired speed, by turning the motor on, or by pulse-width-modulating an input to the motor). A first frame sensor 90 is also coupled to the first controller 82 and configured to provide a first frame signal, based on the first DSM's plurality of frame markers, to the first controller 82.

A second print engine 64 is coupled to the first print engine 58, in this embodiment, by a transport path 92 having an inverter 94. The second print engine 64 has a second dielectric support member (DSM) 96, the features of which have been discussed above with regard to the DSM of FIG. 1. The second DSM 96 also preferably has a plurality of frame markers corresponding to a plurality of frames on the DSM 96. In some embodiments, the frame markers can be holes or perforations in the DSM 96 which an optical sensor can detect. In other embodiments, the frame markers can be reflective or diffuse areas on the DSM which an optical sensor can detect. Other types of frame markers will be apparent to those skilled in the art and are intended to be included within the scope of this specification. The second print engine 64 also has a second motor 98 coupled to the second DSM 96 for moving the second DSM 96 when enabled. As used here, the term “enabled” refers to embodiments where the second motor 98 can be dialed in to one or more desired speeds as opposed to just an on/off operation. Other embodiments, however, can selectively enable the second motor 98 in a pulse-width-modulation fashion.

The second controller 84 is coupled to the second motor 98 and is configured to selectively enable the second motor 98 (for example, by setting the motor for a desired speed, or by pulse-width-modulating an input to the motor). A second frame sensor 100 is also coupled to the second controller 84 and configured to provide a second frame signal, based on the second DSM's plurality of frame markers, to the second controller 84. The second controller 84 is also coupled to the first frame sensor 90 either directly as illustrated or indirectly via the first controller 82 which can be configured to pass data from the first frame sensor 90 to the second controller 84.

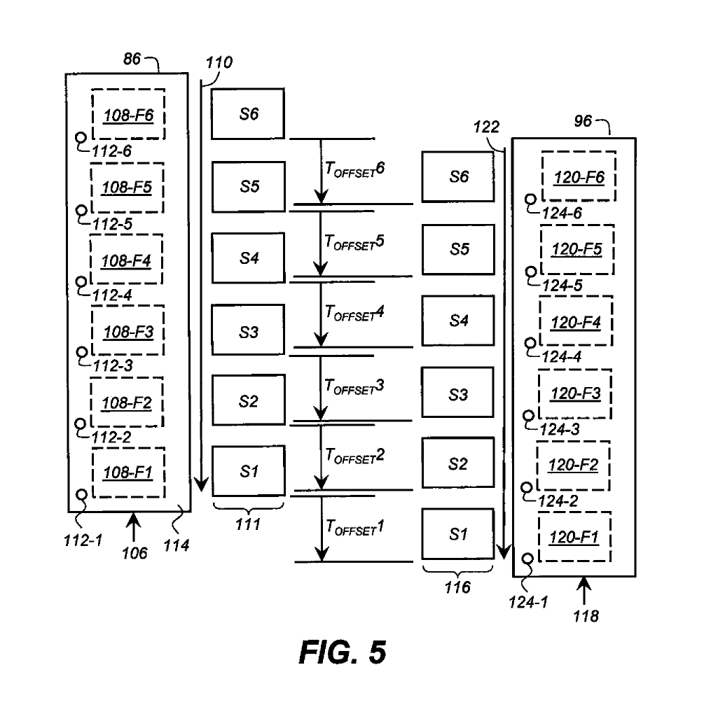

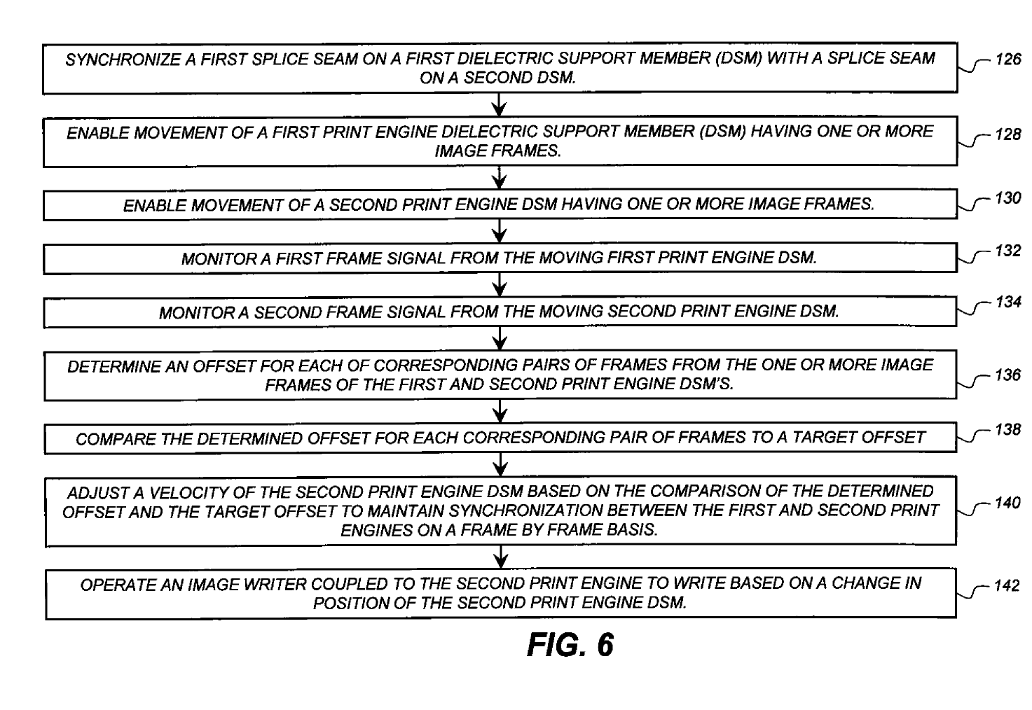

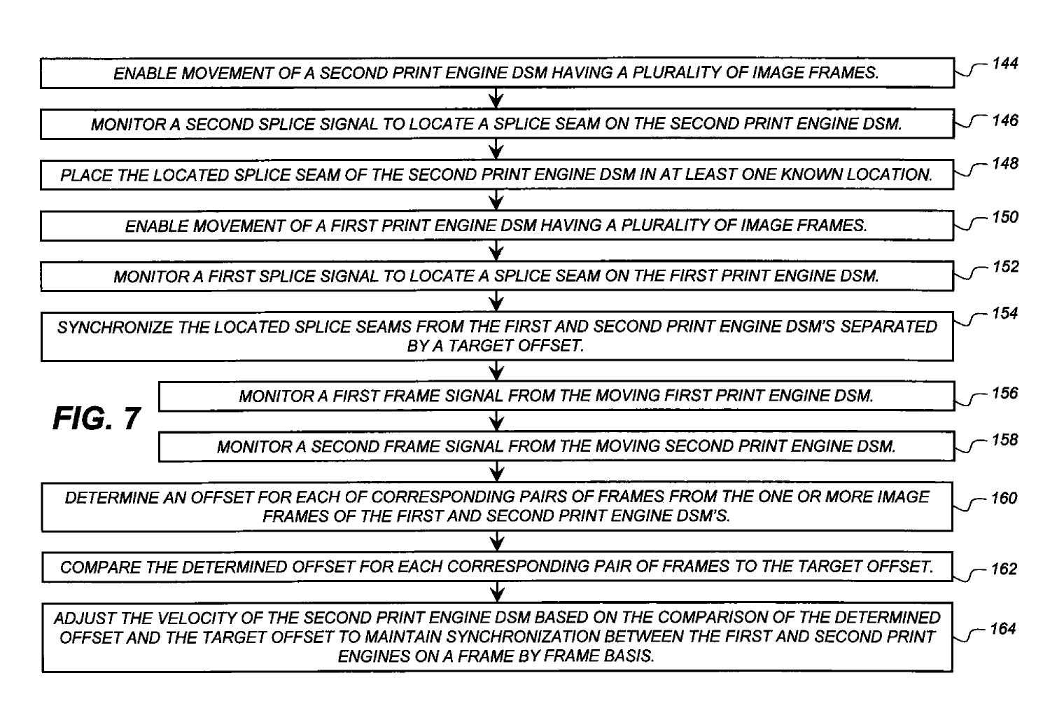

The operation of each individual print engine 58 and 64 has been described on its own. Second controller 84 is also configured to synchronize the first and second print engines 58, 64 on a frame-by-frame basis. Optionally, the second controller 84 can also be configured to synchronize a first DSM splice seam from the first DSM 86 with a second DSM splice seam from the second DSM 96. In embodiments which synchronize the DSM splice seams, the first print engine 58 can have a first splice sensor 102 and the second print engine 64 can have a second splice sensor 104. In other embodiments, the frame sensors 90, 100 can be configured to double as splice sensors. Embodiments of the synchronization which the second controller 84 can be configured to implement will be discussed further-on with regard to FIGS. 6 and 7, but first, FIG. 5 schematically illustrates the importance of synchronizing frames as well as optionally synchronizing DSM splice seams between the first and second print engines.

FIG. 5 schematically illustrates a first dielectric support member (DSM) 86 sliced open on its first splice 106 and laid flat so that first image frames 108-F1 through 108-F6 can be seen. When the motor coupled to the first DSM 86 is enabled, the first DSM 86 moves in a direction 110 which is substantially matched in direction and speed to receiver members S1-S6 during a first time period 111. The first DSM 86 has a plurality of frame markers 112-1 through 112-6 corresponding to image frames 108-F1 through 108-F6. The first controller can be configured to move receiver members S1 through S6 so that the sheets align as desired with the corresponding set of first image frames 108-F1 through 108-F6. A first splice marker 114 can be provided to indicate the position of the splice.

When using print engines in tandem, FIG. 5 also schematically illustrates that during a second time period 116 the receiver members S1 through S6 will sequentially come into contact with the second dielectric support member (DSM) 96. Second DSM 96 is sliced open on its first splice 118 and laid flat so that second image frames 120-F1 through 120-F6 can be seen. When the motor coupled to the second DSM 96 is enabled, the second DSM 96 moves in a direction 122 which is substantially matched in direction and speed to receiver members S1-S6 during the second time period 116. The second DSM 96 also has a plurality of frame markers 124-1 through 124-6 corresponding to image frames 120-F1 through 120-F6.

Ideally, the position of the second DSM 96 image frames will be synchronized with the position of the first DSM 86 image frames with an appropriate offset in time to account for the distance the receiver members travel between the first print engine and the second print engine at a particular speed. Prior art solutions which simply synchronize once based on splice position can drift over time due to variations in first and second DSM lengths and motor non-linearity and fluctuation. Even prior art solutions which attempt to synchronize the DSM's once per revolution of the DSM can experience drift between frames.

An offset (T_{offset}1 through T_{offset}6) can be determined for each corresponding set of frames between the first DSM 86 and the second DSM 96. For example, T_{offset}1 is the offset between the start of frame 108-F1 and frame 120-F1. Ideally the offset is substantially equal to a predetermined or calibrated offset between the first and second print engines based on the length of the transport-path between the first and second print engines and the speed the receiver members are moving through the transport path. Unfortunately, the variations discussed can lead to drift between the determined actual offset and a target offset.

FIG. 6 illustrates one embodiment of a method for synchronizing first and second print engines. Optionally, a first splice seam on a first dielectric support member (DSM) is synchronized 126 with a second splice seam on a second DSM. Synchronizing the splice seams, if the DSM has splice seams, can have the advantage of providing a more consistent interframe spacing, since the interframe area containing the splice seam can be a different length than the other interframe areas. Although there can be variations in DSM construction, it is still preferable to align the splices for interframe consistency.

Movement of a first print engine dielectric support member (DSM) having one or more image frames is enabled 128. The enabling action can take a variety of forms, including, but not limited to, providing a fixed current, providing a variable current, providing a fixed voltage, providing a variable voltage, or providing a pulse-width modulated voltage to a first motor coupled to the first DSM. Movement of a second print engine DSM having one or more image frames is enabled 130. The enabling action can take a variety of forms, including, but not limited to, providing a fixed current, providing a variable current, providing a fixed voltage, providing a variable voltage, or providing a pulse-width modulated voltage to a second motor coupled to the second DSM.

A first frame signal from the moving first print engine DSM is monitored 132. The first frame signal being monitored can come from a variety of sources, for example, but not limited to, one or more frame perforations, one or more frame marks, one or more frame holes, one or more frame reflective areas, or one or more frame diffuse areas on or defined by the second DSM. A second frame signal from the moving second print engine DSM is monitored 134. Similar to the first frame signal, the second frame signal being monitored can come from a variety of sources, for example, but not limited to, one or more frame perforations, one or more frame marks, one or more frame holes, one or more frame reflective areas, or one or more frame diffuse areas on or defined by the second DSM.

An offset is determined 136 for each of corresponding pairs of frames from the one or more image frames of the first and second print engine DSM's. In some embodiments, the determined offset for each of the corresponding pairs can be an offset time between the corresponding frames. In other embodiments, the determined offset for each of the corresponding pairs can be an offset distance produced by multiplying an offset time by a velocity of travel.

The determined offset for each corresponding pair of frames is compared 138 to a target offset. In some embodiments, the target offset can be preset based on a nominal operating speed of a transport path between the first and second print engines multiplied by a known length of the transport path. In other embodiments, the target offset can be determined based on a calibration routine. The calibration routine can be a manual adjustment to a nominal target offset value. In some embodiments, the calibration routine can include:

1) printing a target timing mark on a receiver member with the first print engine;

2) printing a set of calibration timing marks with corresponding offsets on the receiver member with the second print engine;

3) selecting a calibration timing mark from the set of calibration timing marks which is closest to the target timing mark; and

4) providing a controller for the second print engine with the offset corresponding to the selected closest calibration timing mark. In still other embodiments, the calibration routine can be accomplished automatically by monitoring the timing of the receiver member handling path. The reproduction apparatus can be configured with receiver member handling path sensors which note the passage of the receiver member from the first print engine to the second print engine. Thus, the actual target offset time between the two print engines can be determined as the automatically measured time between receiver member handling path sensor readings or some number proportional thereto. In further embodiments, the calibration routine can be based on a dwell time in the receiver member path between the first print engine and the second print engine. For example, if the productivity transport interface 72 is an inverter, then after flipping the receiver member, the inverter drive rollers can have some delay or dwell time until their controller has them forward the receiver member to the following print engine. Therefore, the dwell time can be proportional to the target offset time and the target offset time can be calibrated automatically based on the dwell time which is set.

A velocity of the second print engine DSM is adjusted 140 based on the comparison of the determined offset and the target offset to maintain synchronization between the first and second print engines on a frame by frame basis. This adjustment can include providing the difference between the determined offset and the target offset to a control loop, for example, but not limited to a proportional plus integral control loop or a proportional plus integral plus derivative control loop. Such loops are known to those skilled in the art, for example the types of control loops used in a servo control system. It can even be preferable to set-up the motor coupled to the second DSM as a servo controlled motor.

Depending on the capabilities of the second print engine, the image writer coupled to the second print engine can be configured to operate independently of DSM velocity. One example of such an image writer is an LED writer array. Such an LED writer array writes based on a change in position of the DSM as tracked by a system encoder coupled to the belt movement. The writer monitors the motion of the DSM and when it is determined that the DSM has advanced a line, the LED writer array writes the line. Since the writer is DSM-position-based, there is no downside to changing the velocity of the DSM on the fly, even on a frame-by-frame or more frequent basis. When making frame-by-frame synchronization adjustments, an image writer with a quick response time, such as an LED array, can be an enabling factor, since certain image writers such as spinning polygon mirrors can have too much inertia to be adjusted independently of DSM velocity on an interframe basis. Therefore, optionally, an image writer coupled to the second print engine can be operated 142 to write based on a change in position of the second print engine's DSM. This will enhance the robustness of the second print engine by making the writer immune to changes in DSM velocity.

FIG. 7 illustrates another embodiment of a method for synchronizing first and second print engines. Movement of a second print engine DSM having a plurality of image frames is enabled 144. A second splice signal is monitored 146 to locate a splice seam on the second print engine DSM. The located splice seam of the second print engine DSM is placed 148 in at least one known location. If the located splice seam of the second print engine is placed in a single known location, then the second DSM is parked in a known location. If the located splice seam of the second print engine is placed in more than one known location, then the second DSM is moving, but the location of the seam is being tracked and therefore the known locations keep changing.

Movement of a first print engine DSM having a plurality of image frames is enabled 150. A first splice signal is monitored 152 to locate a splice seam on the first print engine DSM. The located splice seams from the first and second print engine DSM's are synchronized 154 and separated by a target offset. If the second DSM had been parked, then it is started-up or enabled again for the splice seam synchronization.

A first frame signal from the moving first print engine DSM is monitored 156. The first frame signal will indicate the presence or absence of a frame marker on the first DSM as the first frame markers move past a first frame sensor. A second frame signal from the moving second print engine DSM is monitored 158. The second frame signal will indicate the presence or absence of a frame marker on the second DSM as the second frame markers move past a second frame sensor. An offset is determined 160 for each of corresponding pairs of frames from the one or more image frames of the first and second print engine DSM's. The determined offset for each corresponding pair of frames is compared 162 to the target offset. The velocity of the second print engine DSM is adjusted 164 based on the comparison of the determined offset and the target offset to maintain synchronization between the first and second print engines on a frame by frame basis.

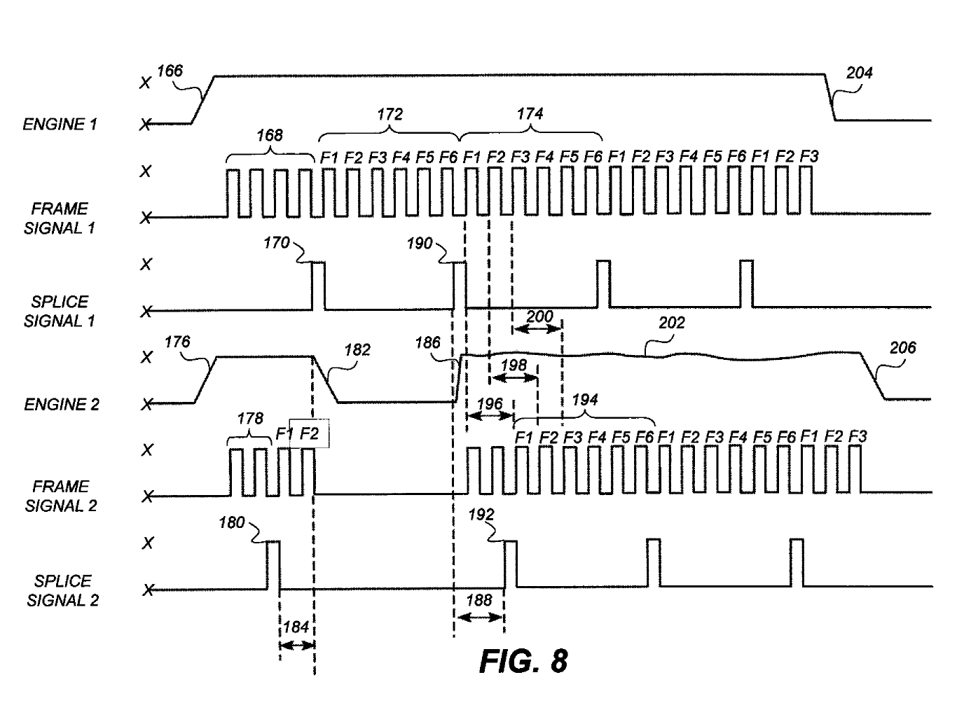

FIG. 8 schematically illustrates a timing diagram representing an embodiment of print engine synchronization. As a first print engine is enabled 166 and the first DSM begins to move, the first frame signal produced by the first frame sensor shows unknown frame pulses 168. The frame pulses are unknown 168 because the location of the first splice has not been determined yet. Eventually, the first splice signal indicates the position 170 of the first splice. From that point on, the individual first frame pulses 172, 174, and so on in a repetitive fashion can be correlated to image frame positions F1 through F6 as illustrated.

As a second print engine is enabled 176 and the second DSM begins to move, the second frame signal produced by the second frame sensor shows unknown frame pulses 178. As before, the frame pulses are unknown 178 because the location of the second splice has not been determined yet. Eventually, the second splice signal indicates the position 180 of the second splice. The second print engine is disabled 182 a desired time 184 after the second splice is detected in order to park the second splice in a known location.

The second print engine can be enabled again 186 at a time calculated to create a starting offset 188 between the first splice 190 and the second splice 192. This establishes the initial synchronization between the first and second splice seams. The recognition of the first splice seam 190 permits the identification of the first image frames F1 through F6 (174) in the first frame signal. Similarly, the recognition of the second splice seam 192 permits the identification of the second image frames F1 through F6 (194) in the second frame signal.

The offsets for corresponding pairs of frames can be determined. For example, offset 196 is the offset between first image frame F1 from the first frame signal and second image frame F1 from the second frame signal. Similarly, offset 198 is the offset between first image frame F2 from the first frame signal and second image frame F2 from the second frame signal. Offset 200 is the offset between first image frame F3 from the first frame signal and second image frame F3 from the second frame signal, and so on.

The determined offsets are compared to a target offset, and the velocity of the second print engine DSM is adjusted as schematically illustrated by the fluctuating portion 202 corresponding to the Engine 2 input. The synchronization occurs on a frame-by-frame basis until it is desired to shut down the first engine 204 and to shut down the second engine 206.

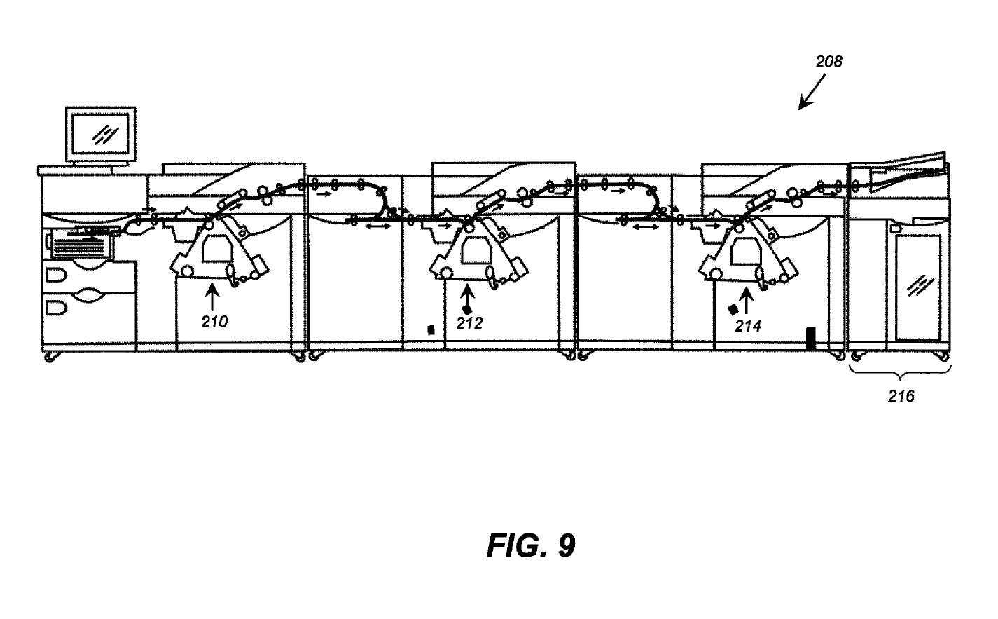

The advantages of a system and method for print engine synchronization have been discussed herein. Embodiments discussed have been described by way of example in this specification. It will be apparent to those skilled in the art that the foregoing detailed disclosure is intended to be presented by way of example only, and is not limiting. For example, the dielectric support members (DSM's) discussed in the embodiments often were illustrated as having six image frames. Other dielectric support members, however, can have fewer or greater numbers of image frames depending on the size of the DSM, the size of the images being printed, and the overall design of the system. Furthermore, although the embodiments herein have been illustrated with a single productivity print engine module inserted in-line with an existing print engine, other embodiments can have any number of additional print engines inserted in-line with the existing print engine. For example, see the reproduction apparatus 208 illustrated in FIG. 9. In addition to the main print engine 210, a second print engine 212 and a third print engine 214 have been installed inline between the main print engine 212 and the finishing device 216. The second print engine 212 can be synchronized with the main print engine 210 using the methods disclosed herein and their equivalents. The third print engine 214 can also be synchronized with the main print engine 210 using the methods disclosed herein and their equivalents. In this case, the target offset will be based on the transit time from the main engine 210 to the third engine 214. Alternatively, the third print engine 214 can be synchronized with the second print engine 212 using the methods disclosed herein and their equivalents. One of the benefits of the disclosed methods is that it permits synchronization between any pair of print engines in the print engine chain. Although it is preferable that the first print engine in the chain of print engines be the main print engine, the end or any of the middle print engines can be the main print engine(s) to which the other print engines are directly or indirectly synchronized.

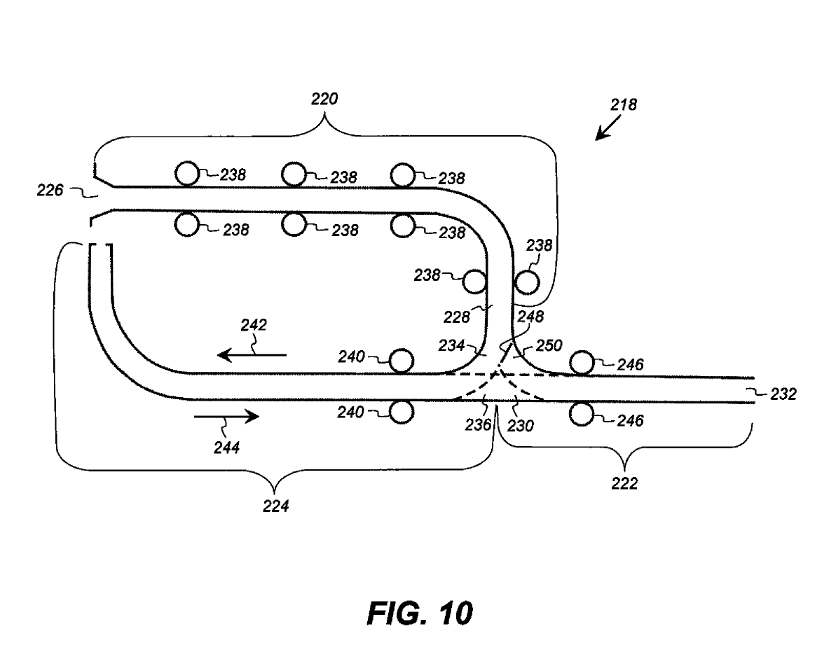

FIG. 10 schematically illustrates one embodiment of an inverter 218 for coupling a first print engine (not shown) to a second print engine (not shown) in a productivity module. The inverter 218 has an input transport path 220, an output transport path 222, and an inversion transport path 224. The term “transport path,” as used here, signifies that the inverter 218 is capable of handling a variety of receiver members, including, but not limited to paper, cardstock, velum, transparencies, plastics, and cardboard. The input transport path 220 has an entrance 226 configured to accept one or more receiver members from the first print engine. The input transport path also has an exit 228. The output transport path 222 has an entrance 230. The output transport path 222 also has an exit 232 configured to supply the one or more receiver members to the second print engine. The inversion transport path 224 has an entrance 234 coupled to the exit 228 of the input transport path 220. The inversion transport path 224 also has an exit 236 coupled to the entrance 230 of the output transport path 222.

The inverter 218 has at least one input drive 238 configured to move receiver members through and out of the input transport path 220. In this embodiment, several input drives 238 are illustrated, however, it should be understood that other embodiments can have more or less input drives 238 depending on the size of the receiver members being moved through the input transport path 220, the amount of control over the receiver members which is desired at a particular position in the input transport path 220, and the type of input drive 238 being used. In this embodiment, the input drives 238 are illustrated as a drive wheel. Other embodiments can use other types of input drives, including, but not limited to, a belt drive and a vacuum drive.

The inverter 218 also has at least one inverter drive 240 configured to move receiver members through and out of the inversion transport path 224. Since this embodiment is a reversing nip inverter, the at least one inverter drive 240 should be reversible to initially pull receiver members in from the entrance 234 of the inversion transport path 224 in a first direction 242 and then push the receiver members out of the exit 236 of the inversion transport path 224 in a second direction 244. In this embodiment, two inverter drives 240 are illustrated, however, it should be understood that other embodiments can have more or less inverter drives 240 depending on the size of the receiver members being moved through the inversion transport path 224, the amount of control over the receiver members which is desired at a particular position in the inversion transport path 224, and the type of inverter drive 240 being used. In this embodiment, the inverter drives 240 are illustrated as a drive wheel. Other embodiments can use other types of inverter drives, including, but not limited to, a belt drive and a vacuum drive.

The inverter 218 also has at least one output drive 246 configured to move receiver members through and out of the output transport path 222. In this embodiment, two output drives 246 are illustrated, however, it should be understood that other embodiments can have more or fewer output drives 246 depending on the size of the receiver members being moved through the output transport path 222, the amount of control over the receiver members which is desired at a particular position in the output transport path 222, and the type of output drive 246 being used. In this embodiment, the output drives 246 are illustrated as a drive wheel. Other embodiments can use other types of output drives, including, but not limited to, a belt drive and a vacuum drive.

The inverter 218 has a diverter 248 operable to selectively couple the exit 228 of the input transport path 220 to either the entrance 234 of the inversion transport path 224 or to a bypass entrance 250 of the output transport path 222. As illustrated in FIG. 10, the position of the diverter 248 is such that the bypass entrance 250 is blocked and the entrance 234 of the inversion transport path 224 is coupled to the exit 228 of the input transport path 220. This position of the diverter 248 can be referred-to as an inversion position. If the diverter 248 is alternately positioned such that the entrance 234 of the inversion transport path 224 is blocked, then the bypass entrance 250 to the output transport path 222 will be coupled to the exit 228 of the input transport path 220. Such an alternate position of the diverter 248 can be referred-to as a non-inversion position.

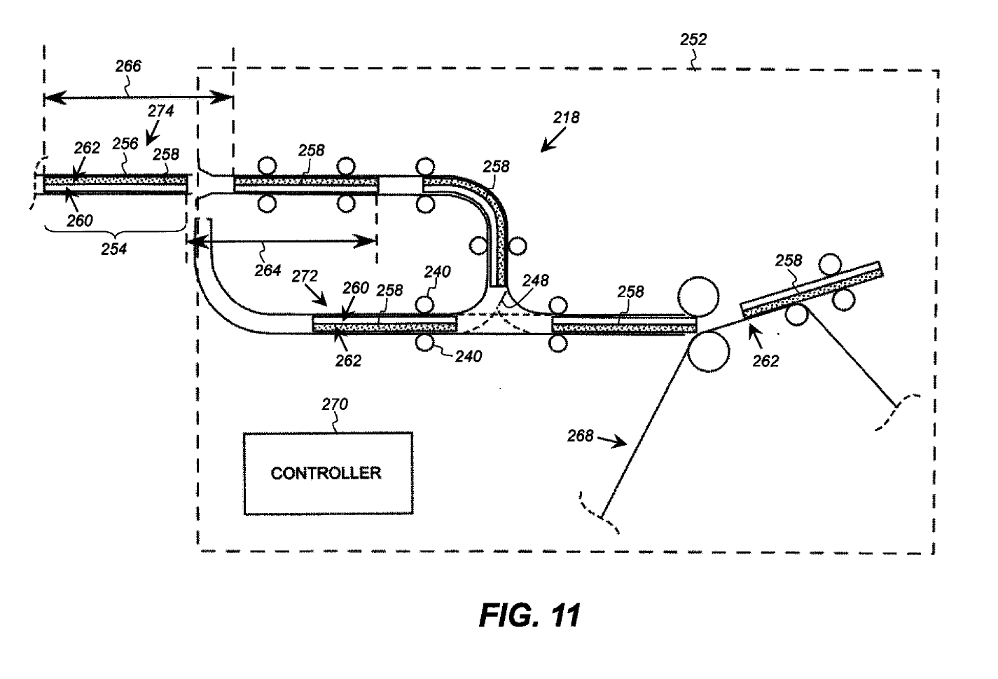

FIG. 11 schematically illustrates an embodiment of a productivity module 252 for increasing duplex throughput of a first print engine 254. The first print engine 254 is only partially illustrated since it is not a part of the productivity module 252. The first print engine 254 has a print engine transport path output 256 which delivers receiver members 258 to the productivity module 252. Each receiver member 258 has a first side 260 and a second side 262. In this embodiment, the first print engine places an image on the first side 260 of the receiver member 258. The receiver members are delivered to the productivity module 252 at a periodic rate. The periodic rate can be based on the time between lead edges 264 or the time between trailing edges 266 of the receiver members 258.

The productivity module 252 has a second print engine 268 which is partially illustrated. Embodiments of the second print engine have been discussed above with regard to previous figures. For simplicity, the exit of the inverter's output transport path is shown coupled directly to the second print engine 268. It should be understood, however, that some embodiments can have a receiver member registration assembly interposed between the inverter's output transport path exit and the print engine 268. In other embodiments, such a registration assembly can be part of the second print engine 268. Registration devices are well-known to those skilled in the art and need not be described in detail herein.

The productivity module 252 also has a controller 270. The controller 270 is configured to receive one or more timing signals from the first print engine 254 and to synchronize timing of the second print engine 268 with the first print engine 254 based at least in part on the timing signals received from the first print engine 254. Suitable embodiments of the synchronization processes have been described above. The controller 270 can be a microprocessor, a computer, an application specific integrated circuit (ASIC), analog circuitry, digital circuitry, or any combination or plurality thereof.

The productivity module 252 also has an inverter 218, the features of which have been discussed above with regard to FIG. 10. When the diverter 248 is in the inversion position as illustrated in FIG. 11, the receiver members 258 are routed through the input transport path and into the inversion transport path where the first side 260 and the second side 262 are placed into a flipped orientation 272 as compared to their initial orientation 274 coming into the productivity module 252. The reversible inverter drive 240 reverses the flipped or inverted receiver member and is configured to send it out of the inversion transport path exit and into the output transport path before the next receiver member entering the inversion transport path can collide with it. As described above, a dwell time of the receiver member in the inversion transport path can be adjusted to permit synchronization of the second print engine 268 with the first print engine 254. The second side 262 of the inverted receiver member can then be imaged by the second print engine 268.

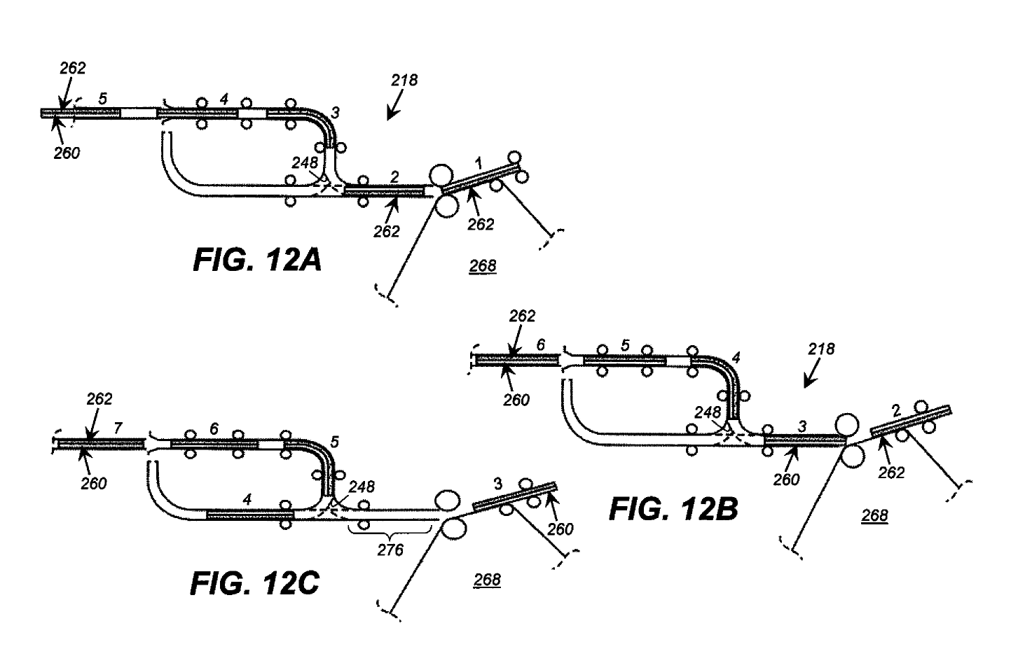

In addition to synchronizing the timing between the print engines, it can also be desirable to increase the productivity in a reproduction apparatus having a first print engine and a second print engine coupled by an inverter when switching between an invert mode and a non-invert mode. For example, FIGS. 12A-12C schematically illustrate embodiments of transport path routing options for an embodiment of an inverter in a productivity module as it switches from an invert mode, to a non-invert mode, and back to the invert mode.

As described above, FIG. 11 illustrated the inverter 218 with the diverter 248 in an inversion position. In FIG. 12A, receiver members 1 and 2 have been inverted following passage through the inversion transport path as described above. However, in FIG. 12A the diverter 248 has been switched to a non-inversion position prior to the entry of receiver member 3 into the inversion transport path. FIG. 12B illustrates a later snapshot in time where receiver members 1 and 2 (which were inverted) have been imaged on the second side 262 by the second print engine 268. Due to the non-inversion position of diverter 248, receiver member 3 has passed through the bypass entrance of the output transport path and is ready to be imaged on its first side 260 by the second print engine 268. Receiver member 4 has not reached the diverter 248 yet, and the diverter 248 will be switched from its illustrated non-inversion position in FIG. 12B back to an inversion position prior to FIG. 12C. As FIG. 12C illustrates, this permits receiver member 4 to be moved into the inversion transport path while receiver member 3 (which was not inverted) moves ahead. This can create a gap 276 between receiver members which can result in the need to skip one or more frames on the DSM, thereby hurting productivity of the reproduction apparatus.

It has been discovered that the relative timing of receiver members when switching back and forth between duplex (inversion) and simplex (non-inversion) modes, will result in the receiver members not being timed to the frames on the dielectric support member (DSM) of the second print engine if the difference in travel time of a receiver member traveling through the inverter while being inverted versus the travel time of a receiver member traveling through the inverter while not being inverted is not an integral multiple of the time period 264, 266 between receiver members. For example, if the difference in travel time between the invert and non-invert modes is equal to the passage of 1.5 frames on the second print engine DSM, a change in mode from the longer invert path to the shorter non-invert path will require the second print engine to skip a single frame before the next receiver member can be imaged. However, there is still a half frame difference, so another frame will need to be skipped before the second consecutive sheet. The half-frame shortfall will persist while in the non-invert mode, resulting in continued skipped frames. Therefore, if the difference between the inversion and the non-inversion travel times for the inverter is not an integral multiple of the time period between receiver members, there will be a persisting productivity hit for mixed duplex/simplex print jobs because every consecutive sheet following a print mode change will arrive at the wrong time.

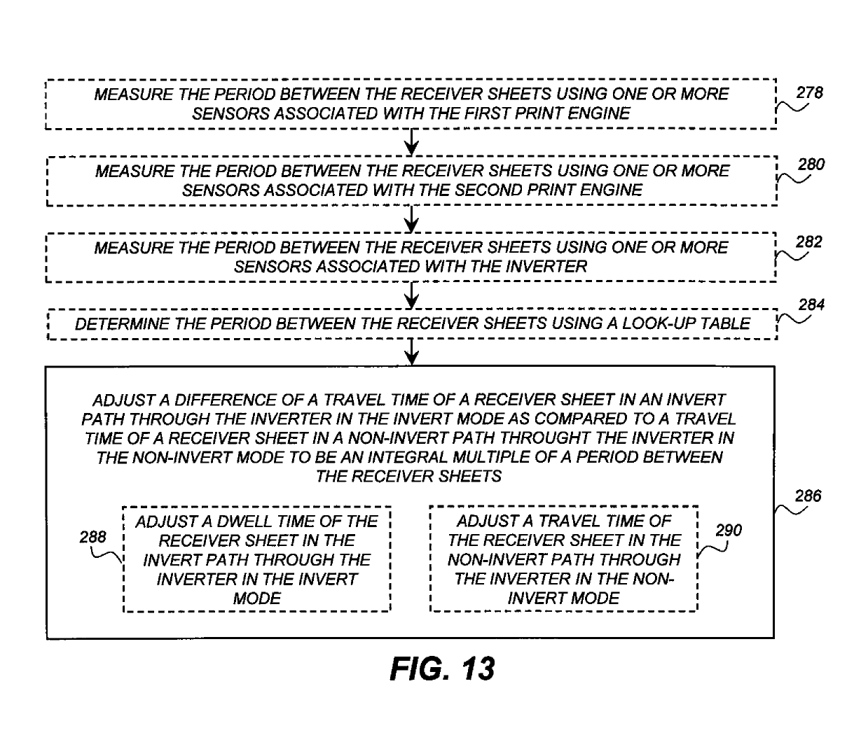

Accordingly, FIG. 13 illustrates one embodiment of a method of increasing productivity in a reproduction apparatus having a first print engine and a second print engine coupled by an inverter when switching between an invert mode and a non-invert mode. If the period between receiver members is not known, then the period between the receiver members can optionally be measured 278 using one or more sensors associated with the first print engine. These sensors can be transport path sensors monitoring leading or trailing edge timing of receiver members passing through the first print engine. The leading edge or trailing edge signals from the one or more sensors can be compared in time to determine the period between receiver members. Alternatively, if the period between receiver members is not known, then the period between the receiver members can optionally be measured 280 using one or more sensors associated with the second print engine. Alternatively, if the period between receiver members is not known, then the period between the receiver members can optionally be measured 282 using one or more sensors associated with the inverter. Alternatively, if the period between receiver members is not known, then the period between the receiver members can optionally be determined 284 using a look-up table. The look-up table can contain pre-determined receiver member periods based on receiver member size or on print engine transport path velocity.

An invert path can be defined as the path a receiver member will take through the inverter in the invert mode as compared to a non-invert path which is defined as the path a receiver member will take through the inverter in the non-invert mode. A difference of a first receiver member travel time through the invert path as compared to a second receiver member travel time through the non-invert path can be adjusted 286 to be an integral multiple of the period between receiver members. Ideally, this multiple is zero, so that the time to travel either path is identical. This permits seamless integration of invert and non-invert modes without the need to skip frames on the either print engine. If the integral multiple is 1 or greater, then there will be a time penalty (in skipped frames on the second print engine) equal to the integral multiple times the period between receiver members when switching modes, but no additional penalty for subsequent receiver members in the switched-to mode.

One example of a way to adjust the difference between the travel time of the receiver member in the invert path and the travel time in the non-invert path is to adjust 288 a dwell time of the receiver member in the invert path through the inverter in the invert mode. Another example of a way to adjust the difference between the travel time of the receiver member in the invert path and the travel time in the non-invert path is to adjust 290 a travel time of the receiver member in the non-invert path through the inverter in the non-invert mode. For example, in some embodiments, it can be preferable to have a speed-up or a slow-down section of the non-invert transport path which can be adjusted for increasing productivity of the reproduction apparatus if the inversion path dwell time is already being adjusted for duplex mode synchronization. In other embodiments, a further example of a way to adjust the difference between the travel time of the receiver member in the invert path versus the travel time in the non-invert path is to adjust a dwell time of a receiver member and adjust a slow-down section of a portion of the transport path which can be adjusted at the same time.

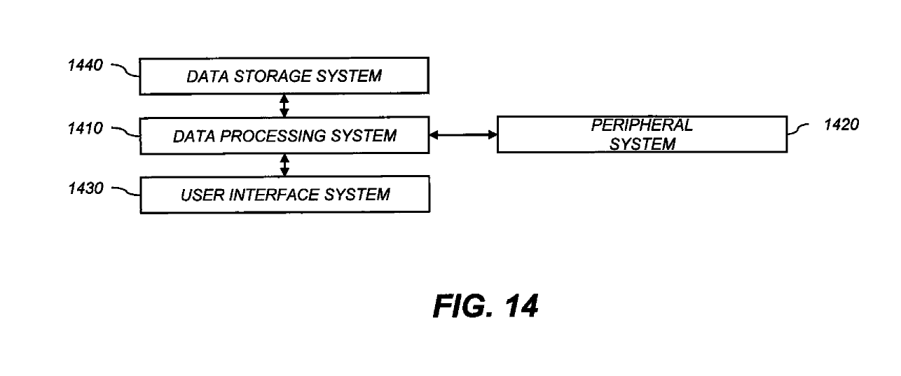

FIG. 14 is a high-level diagram showing the components of a processing system useful with various embodiments. The system includes a data processing system 1410, a peripheral system 1420, a user interface system 1430, and a data storage system 1440. Peripheral system 1420, user interface system 1430 and data storage system 1440 are communicatively connected to data processing system 1410.

Data processing system 1410 includes one or more data processing devices that implement the processes of various embodiments, including the example processes described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

Data storage system 1440 includes one or more processor-accessible memories configured to store information, including the information needed to execute the processes of the various embodiments, including the example processes described herein. Data storage system 1440 can be a distributed processor-accessible memory system including multiple processor-accessible memories communicatively connected to data processing system 1410 via a plurality of computers or devices. On the other hand, data storage system 1440 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. The phrase “communicatively connected” is intended to include a connection between devices or programs within a single data processor, a connection between devices or programs located in different data processors, and a connection between devices not located in data processors at all. In this regard, although the data storage system 1440 is shown separately from data processing system 1410, one skilled in the art will appreciate that data storage system 1440 can be stored completely or partially within data processing system 1410. Further in this regard, although peripheral system 1420 and user interface system 1430 are shown separately from data processing system 1410, one skilled in the art will appreciate that one or both of such systems can be stored completely or partially within data processing system 1410.

Peripheral system 1420 can include one or more devices configured to provide digital content records to data processing system 1410. For example, peripheral system 1420 can include digital still cameras, digital video cameras, cellular phones, or other data processors. Data processing system 1410, upon receipt of digital content records from a device in peripheral system 1420, can store such digital content records in data storage system 1440. Peripheral system 1420 can also include a printer interface for causing a printer to produce output corresponding to digital content records stored in data storage system 1440 or produced by data processing system 1410.

User interface system 1430 can include a mouse, a keyboard, another computer, or any device or combination of devices from which data is input to data processing system 1410. In this regard, although peripheral system 1420 is shown separately from user interface system 1430, peripheral system 1420 can be included as part of user interface system 1430.

User interface system 1430 also can include a display device, a processor-accessible memory, or any device or combination of devices to which data is output by data processing system 1410. In this regard, if user interface system 1430 includes a processor-accessible memory, such memory can be part of data storage system 1440 even though user interface system 1430 and data storage system 1440 are shown separately in FIG. 1.

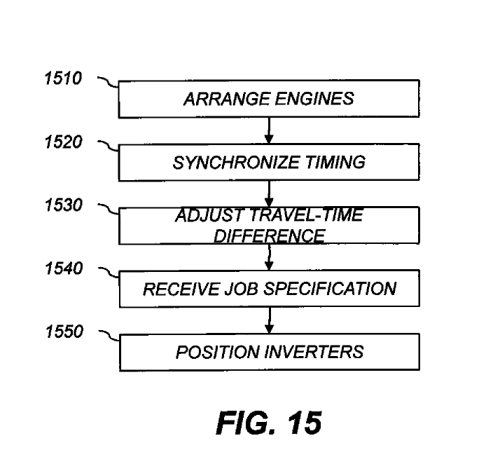

FIG. 15 is a flowchart of various embodiments of methods for producing a multi-component duplex print according to a job specification on a receiver member having front and back sides. The terms “front” and “back” are used to differentiate the two sides of the receiver member and do not imply any orientation or intended use of the sheet. Processing begins with step 1510.

In step 1510, one or more master print engines, one or more slave print engines, and one or more inverters are arranged along a transport path (e.g., a paper path) of the receiver member. An example of print engines and inverters is shown in FIG. 9, discussed above. Each inverter is arranged between a pair of adjacent (consecutive along the transport path) print engines. As a result, each print engine prints (e.g., deposits a respective print image) on a corresponding print side of the moving receiver member, and the first print engine along the transport path prints on the front side of the receiver member. More than one print engine can print on each side of the sheet.

Each master print engine provides a respective timing signal or plurality of timing signals, as will be discussed further below. Each inverter is operative to pass the moving receiver member between the corresponding print engines along an inverted travel path when the inverter is in an invert position and along a non-inverted travel path when the inverter is in a non-invert position. Step 1510 is followed by step 1520.

In step 1520, the timing of each slave print engine is synchronized to the timing of a corresponding master print engine using a controller responsive to the timing signal received from the corresponding master print engine. An example of synchronization is discussed above with reference to FIG. 8, in which engine 1 is the master and engine 2 is the slave. Step 1520 is followed by step 1530.

In step 1530, a difference of a travel time of the receiver member in the inverted travel path of each inverter as compared to a travel time of a receiver member in the non-inverted travel path of that inverter is adjusted to be an integral multiple of a period between successive receiver members. An example of this adjustment is described above with reference to FIG. 13. Step 1530 is followed by step 1540.

In step 1540, the job specification is received. The job specification designates a first assigned one of the print engines to print on a first assigned side of the receiver member. Details of various embodiments are discussed below. Step 1540 is followed by step 1550.

In step 1550, the controller sets the positions of the inverters so the first assigned side of the moving receiver member is the corresponding print side of the first assigned print engine. As a result, the printed receiver member will carry the first assigned print image on the first assigned side of the receiver member, and other print images on selected sides of the receiver member.

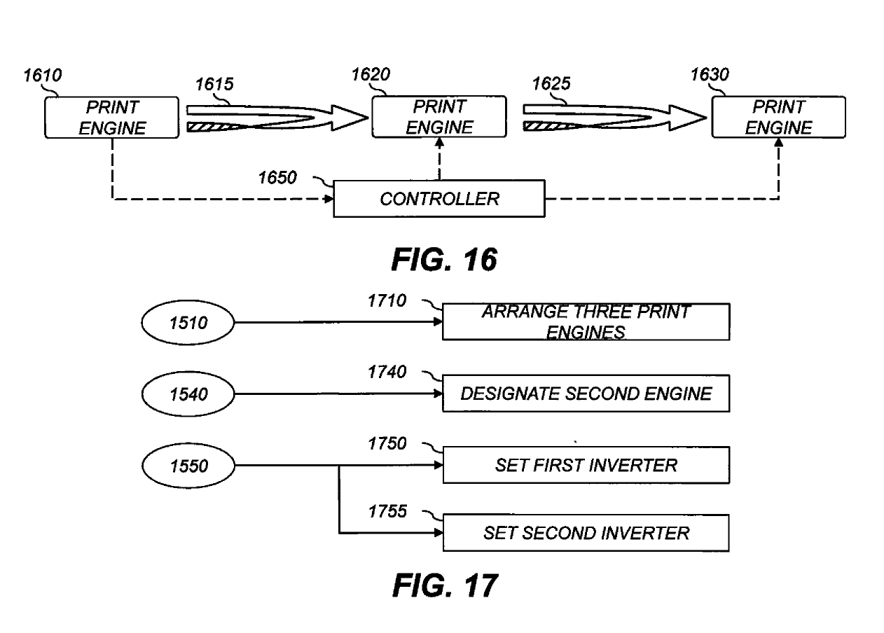

FIGS. 16-25 come in pairs. The even-numbered figure of each pair (e.g., FIG. 16) is a schematic of a printer capable of performing a particular embodiment of the method shown in FIG. 15. The odd-numbered figure of each pair (e.g., FIG. 17) is a flowchart giving details of one or more of the steps shown in FIG. 15, with reference to the hardware of the even-numbered figure (e.g., FIG. 16).

FIG. 16 shows an embodiment of a printer capable of performing the method shown in FIG. 17. For clarity, in this and subsequent even-numbered figures, the receiver moves from left to right along the transport path. Print engines, including print engines 1610, 1620, and 1630, are shown as rounded rectangles. Inverters 1615, 1625 with two travel paths, e.g., inverter 94 (FIG. 4), are shown as double-tailed arrows, with the top arrow representing the non-inverted travel path and the bottom, twisted arrow representing the inverted travel path.

In this example, print engine 1610 is a master print engine and print engines 1620 and 1630 are slave print engines. This is represented graphically by the dashed arrows from print engine 1610 to controller 1650, and from controller 1650 to print engines 1620, 1630. Controller 1650 include a PIC, microcontroller, microprocessor, FPGA, PLA, PLD, PAL, or other analog or digital device capable of synchronizing slave print engines 1620, 1630 to master print engine 1610. Additional details of various embodiments of controller 1650 are given above with reference to FIG. 4. For clarity, master/slave connections and the controller are omitted from subsequent even-numbered figures. Any print engine, e.g., the first or last along the transport path, can be a master. A master can drive one or more slaves. There can be any number of masters, including more than one, along the transport path.

FIG. 17 is a flowchart of details of various embodiments of methods for producing a multi-component duplex print on a receiver member having front and back sides. Referring to FIGS. 16 and 17:

Arranging step 1510 (FIG. 15) includes step 1710. In step 1710, first, second, and third print engines 1610, 1620, and 1630, respectively, are arranged along the transport path. First inverter 1615 is arranged after first print engine 1610. Second inverter 1625 is arranged after second print engine 1620.

Job-specification receiving step 1540 (FIG. 15) includes step 1740. In step 1740, the job specification designating second print engine 1620 is received. That is, the designated print image is to be produced by second print engine 1620.

Setting step 1550 (FIG. 15) includes step 1750 and step 1755.

In step 1750, first inverter 1615 is set to the non-invert position if the first assigned side is the front side of the receiver member, and to the invert position if the first assigned side is the back side of the receiver member.

In step 1755, second inverter 1625 is set to the opposite position from that of the first inverter so that the designated print image is deposited on the selected side. E.g., if first inverter 1615 is set to the non-invert position, second inverter 1625 is set to the invert position, and vice versa.

In an example, first and third print engines 1610, 1630 print using a first marking substance, and second print engine 1620 prints using a second marking substance different from the first marking substance. For example, the first marking substance can be black toner or ink, and the second marking substance can be a spot color. This permits producing a duplex black print with the spot color on either the front or back side. Which side the spot color is on can be changed with each job without requiring any hardware changes. In other embodiments, the second marking substance can be the same as the first marking substance. In one example, the first and second marking substances are large-particle clear toners such as those described in commonly-assigned U.S. Patent Publication No. 20080159786 by Tombs et al., the disclosure of which is incorporated herein by reference. Tactile patterns are produced by depositing clear toner on the front side of the receiver member using print engine 1610 and on the back side of the receiver member using print engine 1630. For security or increased tactile perceptibility, the pattern on one side can be made thicker by overprinting it in second print engine 1620. Alternatively, a second pattern can be overlaid over the first pattern on one side using second print engine 1620.

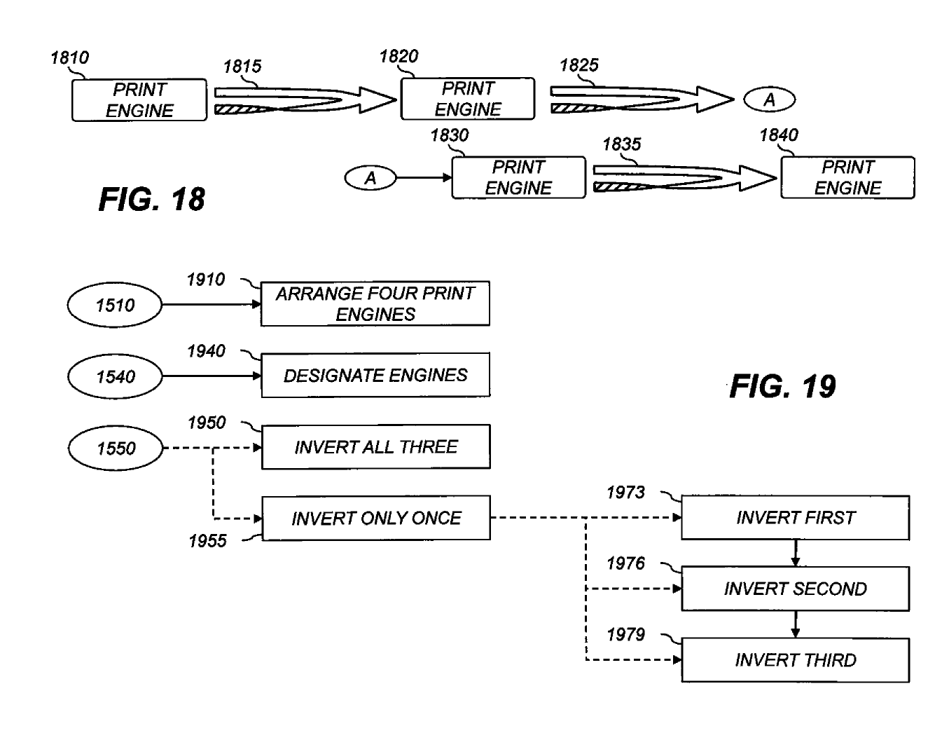

FIG. 18 shows an embodiment of a printer capable of performing the method shown in FIG. 19. Along the transport path are arranged, in order, first print engine 1810, first inverter 1815, second print engine 1820, second inverter 1825, third print engine 1830, third inverter 1835, and fourth print engine 1840.

FIG. 19 is a flowchart of details of various embodiments of methods for producing a multi-component duplex print on a receiver member having front and back sides. Referring to FIGS. 18 and 19:

Arranging step 1510 (FIG. 15) includes step 1910. In step 1910, In step 1910, first, second, third, and fourth print engines 1810, 1820, 1830, and 1840, respectively (all FIG. 18), are arranged along the paper path. First inverter 1815 is arranged after first print engine 1810. Second inverter 1825 is arranged after second print engine 1820. Third inverter 1835 is arranged after third print engine 1830 (all FIG. 18).

Job-specification receiving step 1540 (FIG. 15) includes step 1940. In step 1940, the job specification is received. The job specification designates second print engine 1820 as the first assigned print engine, and designates third print engine 1830 as a second assigned one of the print engines to print (e.g., deposit a second assigned print image) on a second assigned side of the receiver member. The first and second assigned sides can be the same or different.

Setting step 1550 (FIG. 15) includes step 1950 or step 1955, depending on the job specification, as shown in Table 1, below. Step 1955 includes step 1973, 1976, or 1979, also as shown in Table 1. In the example shown in Table 1, first and fourth print engines 1810, 1840 print using a first marking substance, e.g., black (“K”). Second print engine 1820 prints using a second marking substance (“A”) different from the first marking substance. Third print engine 1830 prints using a third marking substance (“B”) different from the first and second marking substances (in other embodiments, the second and third marking substances are the same). For example, A and B can be spot colors such as green and red. In this example, therefore, a duplex print is produced with K on both sides, and components A and B are each applied to a designated side, either front or back. The “Positioned to invert?” columns show whether the referenced inverter on FIG. 18 is in the invert position (“Yes”) or the non-invert position (“no”) The “Result” column in Table 1 shows the components printed on the front side of the receiver member above the components printed on the back side of the receiver member. For example, embodiments using step 1950 produce prints with K and B on the front, K laid down first, and A and K on the back, A laid down first.

Table 1
Positioned to invert?

| Step(s) | 1815 | 1825 | 1835 | Result |
|---|---|---|---|---|
| 1950 | Yes | Yes | Yes | (front) KB |
| | | | | (back) AK |
| 1955, 1973 | Yes | no | no | K |
| | | | | ABK |
| 1955, 1976 | no | Yes | no | KA |
| | | | | BK |
| 1955, 1979 | no | no | Yes | KAB |
| | | | | K |

In step 1950, the three inverters 1815, 1825, 1835 are set to the invert position. This is performed if the first assigned side is the back side and the second assigned side is the front side.

In step 1955, exactly one of the three inverters 1815, 1825, 1835 is set to the invert position. The remaining two of the three inverters are set to the non-invert position. Step 1955 is followed by step 1973, step 1976, or step 1979, according to the job specification.

In step 1973, if the first and second assigned sides are both the back side, only first inverter 1815 is set to the invert position.

In step 1976, if the first assigned side is the front side and the second assigned side is the back side, only second inverter 1825 is set to the invert position.

In step 1979, if the first and second assigned sides are both the front side, only third inverter 1835 is set to the invert position.

In other embodiments, each of the three inverters can be set independently to produce other combinations of print images on various sides. At least one of the inverters 1815, 1825, 1835 is set to the invert position so that a duplex print is produced. Possibilities not listed above include those in Table 2, below.

Table 2
Positioned to invert?

| 1815 | 1825 | 1835 | Result |
|---|---|---|---|
| no | no | no | Simplex KABK |
| no | Yes | Yes | KAK |
| | | | B |
| Yes | no | Yes | KK |
| | | | AB |
| Yes | Yes | no | KBK |
| | | | A |

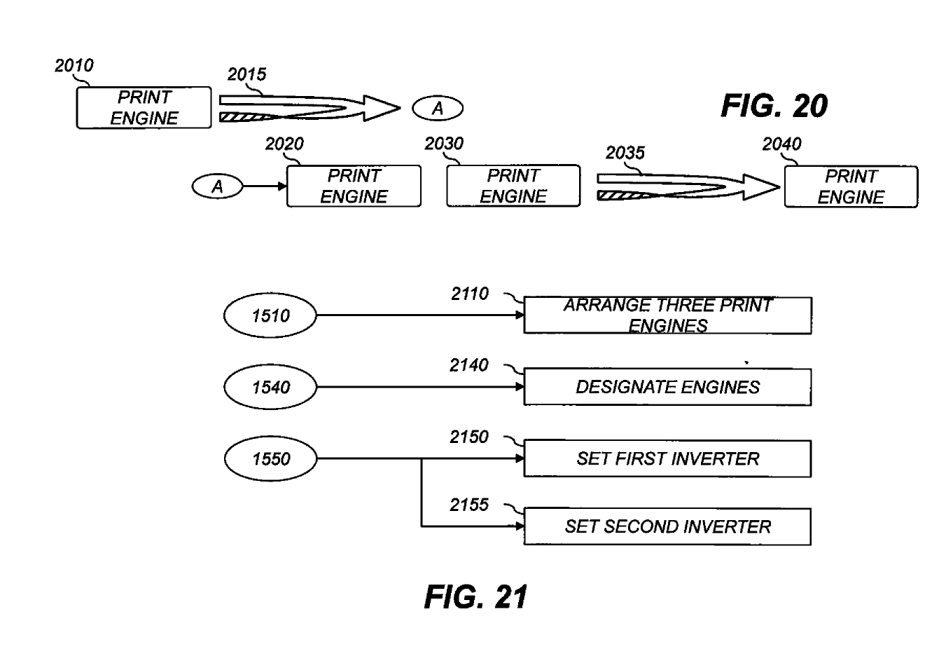

FIG. 20 shows an embodiment of a printer capable of performing the method shown in FIG. 21. Along the transport path are arranged, in order, first print engine 2010, first inverter 2015, second print engine 2020, third print engine 2030, second inverter 2035, and fourth print engine 2040.

FIG. 21 is a flowchart of details of various embodiments of methods for producing a multi-component duplex print on a receiver member having front and back sides. Referring to FIGS. 20 and 21: Arranging step 1510 (FIG. 15) includes step 2110. In step 2110, first, second, third, and fourth print engines 2010, 2020, 2030, and 2040, respectively (all FIG. 20), are arranged along the paper path. First inverter 2015 is arranged after first print engine 2010. Second inverter 2035 is arranged after third print engine 2030.

Job-specification receiving step 1540 (FIG. 15) includes step 2140. In step 2140, the job specification is received. The job specification designates the second print engine as the first assigned print engine, and designates the third print engine as a second assigned one of the print engines to print (e.g., deposit a second assigned print image) on the first assigned side of the receiver member. That is, the print images from print engines 2020, 2030 are printed on the same side.

Setting step 1550 (FIG. 15) includes step 2150 and step 2155.

In step 2150, first inverter 2015 is set to the non-invert position if the first assigned side is the front side of the receiver member, and to the invert position if the first assigned side is the back side of the receiver member.

In step 2155, second inverter 2035 is set to the opposite position from that of the first inverter so that the designated print image is deposited on the selected side.

In an example, first print engine 2010 and fourth print engine 2040 print using a first marking substance. Second print engine 2020 prints using a second marking substance different from the first marking substance. Third print engine 2030 prints using a third marking substance different from the first and second marking substances (the third can also be the same as the second, e.g., for thick textures using clear toner, as described above). In this example, a duplex print is produced with the first marking substance, and the second and third marking substances are spot colors that are applied to one side of the job. In an example, the first marking substance is black. The second marking substance is the trade-dress yellow in the KODAK brand logo. The third marking substance is the trade-dress red in the KODAK brand logo. This configuration permits producing letterhead with the logo on the front side, and corporate invitation cards with the logo on the back side (inside, when folded), without changing hardware. The logo can be on a different side for each print job, and the printer will continue to run at full speed. In embodiments, frames on the photoreceptor are skipped while changing operating modes. The number of skipped frames is the integral multiplier of the timing difference between the inverted and noninverted travel paths.

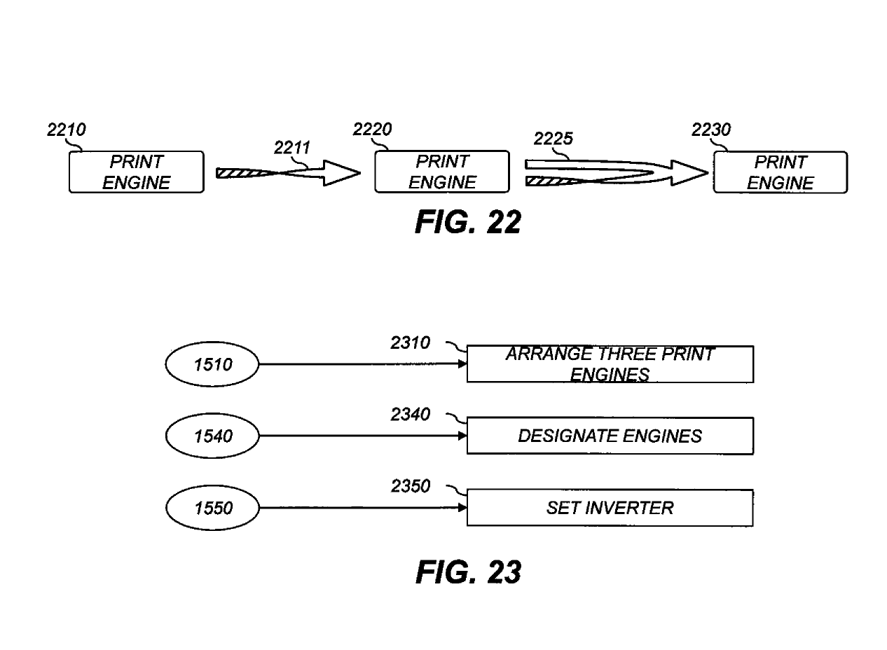

FIG. 22 shows an embodiment of a printer capable of performing the method shown in FIG. 23. Along the transport path are arranged, in order, first print engine 2210, flipper 2211, second print engine 2220, inverter 2225, and third print engine 2230. Flipper 2211 is an inverter without a non-invert path, i.e., a device that flips each sheet passing through it. Flipper 2211 is represented graphically as a single-twisted-tail arrow.

FIG. 23 is a flowchart of details of various embodiments of methods for producing a multi-component duplex print on a receiver member having front and back sides. Referring to FIGS. 22 and 23:

Arranging step 1510 (FIG. 15) includes step 2310. In step 2310, first, second, and third print engines 2210, 2220, and 2230, respectively (all FIG. 22), are arranged along the paper path. Inverter 2225 is arranged after second print engine 2220. Flipper 2211 is arranged between first print engine 2210 and second print engine 2220 (all FIG. 22). Flipper 2211 flips the moving receiver member so that second print engine 2220 prints on the back side of the receiver member (since first print engine 2210 prints on the front side of the receiver member, as discussed above with reference to FIG. 1510).

Job-specification receiving step 1540 (FIG. 15) includes step 2340. In step 2340, the job specification is received, and designates third print engine 2230.

Setting step 1550 (FIG. 15) includes step 2350. In step 2350, inverter 2225 is set to the non-invert position if the first assigned side is the back side of the receiver member, and to the invert position if the first assigned side is the front side of the receiver member.

In various embodiments, the first and second print engines 2210, 2220 print using a first marking substance. Third print engine 2230 prints using a second marking substance different from the first marking substance. For example, the first marking substance can be black and the second marking substance can be a spot color.

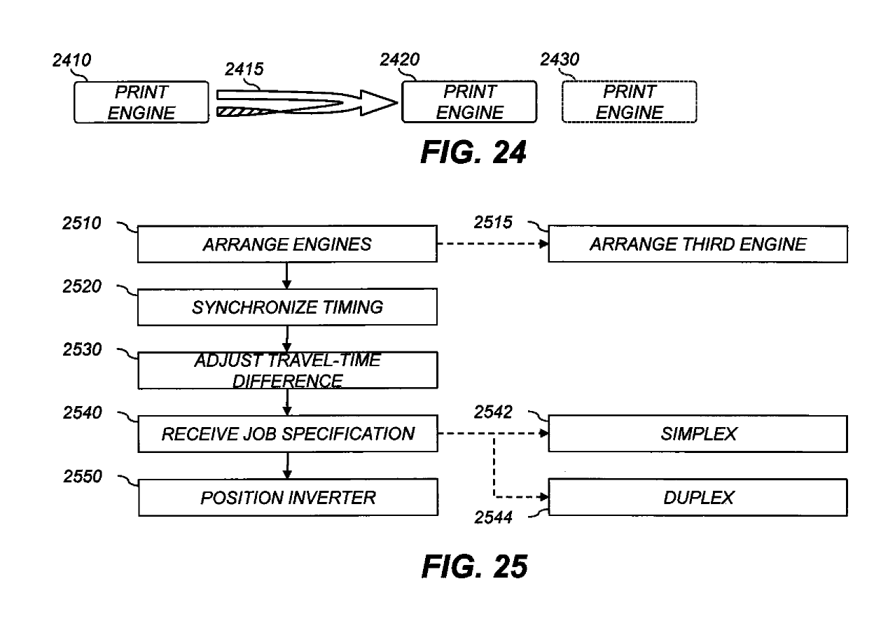

FIG. 24 shows an embodiment of a printer capable of performing the method shown in FIG. 25. Along the transport path are arranged, in order, first print engine 2410, inverter 2415, second print engine 2420, and optional third print engine 2430. In an example, both print engines use clear toner, and the printer can produce thin textures on both sides (duplex) or thick textures on one side (simplex).

FIG. 25 is a flowchart of method for producing a multi-component print on a receiver member having front and back sides according to a job specification. Processing begins with step 2510. Referring to FIGS. 24 and 25:

In step 2510, a master print engine, a slave print engine, and an inverter 2415 are arranged along a transport path of the receiver member. First print engine 2410 can be the master or the slave, and second print engine 2420 can be the slave or the master. The inverter is arranged between the first and second print engines 2410, 2420. As a result, each print engine prints on a corresponding print side of the moving receiver member, and the first print engine along the transport path prints on the front side of the receiver member. The master print engine provides a respective timing signal. The inverter is operative to pass the moving receiver member between the print engines along an inverted travel path when the inverter is in an invert position and along a non-inverted travel path when the inverter is in a non-invert position. Step 2510 is followed by step 2520 and optionally by step 2515, discussed below.

In step 2520, the timing of the slave print engine is synchronized to the timing of the master print engine using a controller responsive to the timing signal received from the master print engine. Step 2520 is followed by step 2530.

In step 2530, a difference of a travel time of the receiver member in the inverted travel path of each inverter as compared to a travel time of a receiver member in the non-inverted travel path of that inverter is adjusted to be an integral multiple of a period between successive receiver members. Step 2530 is followed by step 2540.

In step 2540, the job specification is received. The job specification designates a first assigned one of the print engines to print on a first assigned side of the receiver member, and a second assigned one of the print engines to print on a second assigned side of the receiver member. Step 2540 is followed by step 2550, and in various embodiments by step 2542 or step 2544.

In step 2550, the controller sets the position of the inverter so the first assigned side of the moving receiver member is the corresponding print side of the first assigned print engine and the second assigned side of the moving receiver member is the corresponding print side of the second assigned print engine.

In various embodiments, in step 2542, the job specification is received assigning the first and second sides to be the front side of the receiver member, so that the printer produces a multi-component simplex print.

In various embodiments, in step 2544, the job specification is received assigning the first and second sides to be opposite sides of the receiver member, so that the printer produces a duplex print.

In various embodiments, step 2515 follows step 2510. In step 2515, third print engine 2430 is arranged along the transport path after second print engine 2420 along the transport path so that third print engine prints on the same side of the moving receiver member as the second print engine along the transport path. Third print engine 2430 can be a slave or a master. In other embodiments, print engine 2420 is equipped with two colorants or marking materials to produce two print images on the corresponding side of the receiver member. Marking materials can include MICR (magnetic) ink particles, colorants, fluorescent materials, security materials, overcoat materials, or clear protectant materials. Marking materials can include particles of various sizes, e.g., <6 μm, <8 μm, or >12 μm in diameter. For example, toner particles can have a range of diameters, e.g., less than 8 μm, on the order of 10-15 μm, up to approximately 30 μm, or larger (“diameter” refers to the volume-weighted median diameter, as determined by a device such as a Coulter Multisizer).

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. The word “or” is used in this disclosure in a non-exclusive sense, unless otherwise explicitly noted.

The invention has been described in detail with particular reference to certain preferred embodiments thereof, but it will be understood that variations, combinations, and modifications can be effected by a person of ordinary skill in the art within the spirit and scope of the invention.

### PARTS LIST

30 print engine
32 photo conductive belt/dielectric support member (DSM)
32a surface
34a driven roller
34b roller
34c roller
34d roller
34e roller
34f roller
34g roller
36 motor
38 primary charging station
40 exposure station (image writer)
40a writer
42 development station
42a backup roller
44 transfer station
46 receiver member
48 biasing roller
50 fuser station
52 cleaning station
54 belt position sensor
56 reproduction apparatus
58 first print engine
60 main cabinet
62 finishing device
64 second print engine
66 input transport path point
68 output transport path point
70 productivity module
72 productivity transport interface
74 matching of differing output and input receiver-sheet heights
76 inversion of receiver members
78 reproduction apparatus
80 controller
82 first controller
84 second controller
86 first dielectric support member (DSM)
88 first motor
90 first frame sensor
92 transport path
94 inverter
96 second dielectric support member (DSM)
98 second motor
100 second frame sensor
102 first splice sensor
104 second splice sensor
106 splice for first DSM
108-F1 image frame 1 on the first DSM
108-F2 image frame 2 on the first DSM
108-F3 image frame 3 on the first DSM
108-F4 image frame 4 on the first DSM
108-F5 image frame 5 on the first DSM
108-F6 image frame 6 on the first DSM
110 direction of first DSM movement
111 first time period for receiver members S1-S6
112-1 frame marker 1 on the first DSM
112-2 frame marker 2 on the first DSM
112-3 frame marker 3 on the first DSM
112-4 frame marker 4 on the first DSM
112-5 frame marker 5 on the first DSM
112-6 frame marker 6 on the first DSM
114 splice marker on the first DSM
116 second time period for receiver members S1-S6
118 splice for second DSM
120-F1 image frame 1 on second DSM
120-F2 image frame 2 on second DSM
120-F3 image frame 3 on second DSM
120-F4 image frame 4 on second DSM
120-F5 image frame 5 on second DSM
120-F6 image frame 6 on second DSM
122 direction of second DSM movement
124-1 frame marker 1 on the second DSM
124-2 frame marker 2 on the second DSM
124-3 frame marker 3 on the second DSM
124-4 frame marker 4 on the second DSM
124-5 frame marker 5 on the second DSM
124-6 frame marker 6 on the second DSM
126 synchronize first splice seam step
128 enable movement of 1^{st} print engine step
130 enable movement of 2^{nd} print engine step
132 monitor first frame signal step
134 monitor second frame signal step
136 determine offset of corresponding pairs step
138 compare determined offset step
140 adjust velocity of 2^{nd} print engine step
142 operate image writer step
144 enable movement of 2^{nd} print engine step
146 monitor second splice signal step
148 place splice seam in known location step
150 enable movement of 1^{st} print engine step
152 monitor first splice signal step
154 synchronize located splice seams step
156 monitor first frame signal step
158 monitor second frame signal step
160 determine offset of corresponding pairs step
162 compare determined offset step
164 adjust velocity of 2^{nd} print engine step
166 first print engine enabled
168 unknown image frames in the first frame signal
170 first splice on the first splice signal
172 first frame pulses F1-F6 in the first frame signal
174 repetition of first frame pulses F1-F6 in the first frame signal
176 second print engine enabled
178 unknown frame pulses in the second frame signal
180 position of the second splice
182 disable of the second print engine
184 desired disable time after second splice
186 second print engine re-enabled
188 starting offset
190 first splice
192 second splice
194 second image frames F1-F6 in the second frame signal
196 offset between first image frame F1 from the first frame signal and second image frame F1 from the second frame signal
198 offset between first image frame F2 from the first frame signal and second image frame F2 from the second frame signal
200 offset between first image frame F3 from the first frame signal and second image frame F3 from the second frame signal
202 fluctuating portion of the engine 2 input
204 first engine shutdown
206 second engine shutdown
208 reproduction apparatus
210 first print engine
212 second print engine
214 third print engine
216 finishing device
218 inverter
220 input transport path
222 output transport path
224 inversion transport path
226 input transport path entrance
228 input transport path exit
230 output transport path entrance
232 output transport path exit
234 inversion transport path entrance
236 inversion transport path exit
238 input drive
240 inverter drive
242 first direction
244 second direction
246 output drive
248 diverter
250 bypass entrance of the output transport path
252 productivity module
254 first print engine (partially illustrated)
256 transport path output of the first print engine
258 receiver member
260 first side of the receiver member
262 second side of the receiver member
264 period between receiver members
266 period between receiver members
268 second print engine (partially illustrated)
270 controller
272 flipped orientation
274 initial orientation
276 gap between receiver members when switching modes
278 measurement step
280 measurement step
282 measurement step
284 determine period step
286 adjust difference of travel times step
288 adjust dwell time step
290 adjust travel time step
1410 data processing system
1420 peripheral system
1430 user interface system
1440 data storage system
1510 arrange engines step
1520 synchronize timing step
1530 adjust travel-time difference step
1540 receive job specification step
1550 position inverters step
1610 print engine
1615 inverter
1620 print engine
1625 inverter
1630 print engine
1650 controller
1710 arrange three print engines step
1740 designate second engine step
1750 set first inverter step
1755 set second inverter step
1810 print engine
1815 inverter
1820 print engine
1825 inverter
1830 print engine
1835 inverter
1840 print engine
1910 arrange four print engines step
1940 designate engines step
1950 invert three step
1955 invert only once step
1973 invert first step
1976 invert second step
1979 invert third step
2010 print engine
2015 inverter
2020 print engine
2030 print engine
2035 inverter
2040 print engine
2110 arrange three print engines step
2140 designate engines step
2150 set first inverter step
2155 set second inverter step
2210 print engine
2211 flipper
2220 print engine
2225 inverter
2230 print engine
2310 arrange three print engines step
2340 designate engines step
2350 set inverter step
2410 print engine
2415 inverter
2420 print engine
2430 print engine
2510 arrange engines step
2515 arrange third engine step
2520 synchronize timing step
2530 adjust travel-time difference step
2540 receive job specification step
2542 simplex step
2544 duplex step
2550 position inverter step
S1 first receiver member
S2 second receiver member
S3 third receiver member
S4 fourth receiver member
S5 fifth receiver member
S6 sixth receiver member

1. A method for producing a multi-component duplex print on a receiver member having front and back sides according to a job specification, the method comprising:
arranging one or more master print engines, one or more slave print engines, and one or more inverters along a transport path of the receiver member, each inverter arranged between a pair of adjacent print engines,
so that each print engine prints on a corresponding print side of the moving receiver member, and the first print engine along the transport path prints on the front side of the receiver;
wherein each master print engine provides a respective timing signal and each inverter is operative to pass the moving receiver member between the corresponding print engines along an inverted travel path when in an invert position and along a non-inverted travel path when in a non-invert position;
synchronizing the timing of each slave print engine to the timing of a corresponding master print engine using a controller responsive to the timing signal received from the corresponding master print engine;
adjusting a difference of a travel time of the receiver member in the inverted travel path of each inverter as compared to a travel time of a receiver member in the non-inverted travel path of that inverter to be an integral multiple of a period between successive receiver members;
receiving the job specification designating a first assigned one of the print engines to print on a first assigned side of the receiver member; and
the controller setting the positions of the inverters so the first assigned side of the moving receiver member is the corresponding print side of the first assigned print engine.

2. The method according to claim 1, wherein:
the arranging step includes arranging first, second, and third print engines along the transport path with first and second inverters after the first and second print engines, respectively;
the job specification designates the second print engine; and
the setting step includes:
setting the first inverter to the non-invert position if the first assigned side is the front side of the receiver member, and to the invert position if the first assigned side is the back side of the receiver member; and
setting the second inverter to the opposite position from that of the first inverter.

3. The method according to claim 2, wherein the first and third print engines print using a first marking substance and the second print engine prints using a second marking substance different from the first marking substance.

4. The method according to claim 1, wherein:
the arranging step includes arranging first, second, third, and fourth print engines along the transport path with first, second, and third inverters after the first, second, and third print engines, respectively;
the job specification designates the second print engine as the first assigned print engine, and designates the third print engine as a second assigned one of the print engines to print on a second assigned side of the receiver member; and
the setting step includes setting exactly one of the three inverters to the invert position and the remaining two of the three inverters to the non-invert position, or setting the three inverters to the invert position.

5. The method according to claim 4, wherein the first and fourth print engines print using a first marking substance, the second print engine prints using a second marking substance different from the first, and the third print engine prints using a third marking substance different from the first and second.

6. The method according to claim 4, wherein the setting step includes a step selected from the group comprising:
setting the three inverters to the invert position if the first assigned side is the back side and the second assigned side is the front side;
setting only the first inverter to the invert position if the first and second assigned sides are both the back side;
setting only the second inverter to the invert position if the first assigned side is the front side and the second assigned side is the back side; and
setting only the third inverter to the invert position if the first and second assigned sides are both the front side.

7. The method according to claim 1, wherein:
the arranging step includes arranging first, second, third, and fourth print engines along the transport path with first and second inverters after the first and third print engines, respectively;
the job specification designates the second print engine as the first assigned print engine, and designates the third print engine as a second assigned one of the print engines to print on the first assigned side of the receiver member; and
the setting step includes:
setting the first inverter to the non-invert position if the first assigned side is the front side of the receiver member, and to the invert position if the first assigned side is the back side of the receiver member; and
setting the second inverter to the opposite position from that of the first inverter.

8. The method according to claim 7, wherein the first and fourth print engines print using a first marking substance, the second print engine prints using a second marking substance different from the first, and the third print engine prints using a third marking substance different from the first and second.

9. The method according to claim 1, wherein:
the arranging step includes arranging first, second, and third print engines along the transport path with an inverter after the second print engine, and disposing a flipper between the first and second print engines effective to flip the moving receiver member so that the second print engine prints on the back side of the receiver member;
the job specification designates the third print engine; and
the setting step includes setting the inverter to the non-invert position if the first assigned side is the back side of the receiver member, and to the invert position if the first assigned side is the front side of the receiver member.

10. The method according to claim 9, wherein the first and second print engines print using a first marking substance and the third print engine prints using a second marking substance different from the first marking substance.

11. The method according to claim 1, wherein the print engines are electrophotographic print engines.

12. The method according to claim 1, wherein the print engines are inkjet print engines.

13. A method for producing a multi-component print on a receiver member having front and back sides according to a job specification, the method comprising:
arranging a master print engine, a slave print engine, and an inverter along a transport path of the receiver member, the inverter arranged between the print engines,
so that each print engine prints on a corresponding print side of the moving receiver member, and the first print engine along the transport path prints on the front side of the receiver;
wherein the master print engine provides a respective timing signal and the inverter is operative to pass the moving receiver member between the print engines along an inverted travel path when in an invert position and along a non-inverted travel path when in a non-invert position;
synchronizing the timing of the slave print engine to the timing of the master print engine using a controller responsive to the timing signal received from the master print engine;
adjusting a difference of a travel time of the receiver member in the inverted travel path of the inverter as compared to a travel time of a receiver member in the non-inverted travel path of the inverter to be an integral multiple of a period between successive receiver members;
receiving the job specification designating a first assigned one of the print engines to print on a first assigned side of the receiver member, and a second assigned one of the print engines to print on a second assigned side of the receiver member; and
the controller setting the position of the inverter so the first assigned side of the moving receiver member is the corresponding print side of the first assigned print engine and the second assigned side of the moving receiver member is the corresponding print side of the second assigned print engine.

14. The method according to claim 13, wherein the job specification assigns the first and second sides to be the front side of the receiver member, so that the printer produces a multi-component simplex print.

15. The method according to claim 13, wherein the job specification assigns the first and second sides to be opposite sides of the receiver member, so that the printer produces a duplex print.

16. The method according to claim 13, wherein the arranging step further includes arranging a third print engine along the transport path after the second print engine along the transport path so that the third print engine prints on the same side of the moving receiver member as the second print engine along the transport path.
